(19) United States
(12) Patent Application Publication
(10) Pub. No.: US 2013/0316773 A1
(43) Pub. Date: Nov. 28, 2013

(54) SYSTEM AND METHOD FOR THE CREATION OF AN ENHANCED MULTI-DIMENSIONAL PICTOGAME USING PICTOOVERLAY TECHNOLOGY

(71) Applicant: Ian A. R. Boyd, North Las Vegas, NV (US)

(72) Inventor: Ian A. R. Boyd, North Las Vegas, NV (US)

(21) Appl. No.: 13/829,838

(22) Filed: Mar. 14, 2013

Related U.S. Application Data
(60) Provisional application No. 61/652,306, filed on May 28, 2012.
(60) Provisional application No. 61/705,686, filed on Sep. 26, 2012.
(60) Provisional application No. 61/716,508, filed on Oct. 20, 2012.
(60) Provisional application No. 61/750,022, filed on Jan. 8, 2013.
(60) Provisional application No. 61/763,749, filed on Feb. 12, 2013.

(51) Int. Cl. A63F 13/00

(52) U.S. Cl. CPC A63F 13/00
USPC 463/9

(57) ABSTRACT

A software application program on a computer platform dynamically transforms a collage image of vivid pictorial images into a series of games of skill and chance that entertain, educate and intrigue. Using PictoOverlay Technology, Enhanced Multi-Dimensional PictoGames engage a user to accept and complete a series of challenges that result in receiving scores based on elapsed time and the completion of each challenge. The PictoGames are presented through a series of moving pictures with audio and visual special effects and enhancements that end up making features of the collage image come alive visually, and intrigue a user to play while improving their cognitive skills. The software program further transforms the pictorial images into an infinitely variable array of elements and enhancements that allow a user to play the PictoGame individually, with teammates, or against one or more opponents.

### CROSS REFERENCE TO RELATED APPLICATIONS

This application claims the benefit of U.S. Provisional Application No. 61/652,306 filed May 28, 2012 entitled AUDIO VIDEO FILM CREATOR FROM STORYLINE, CAST AND CONTEXT SETTINGS INPUT, U.S. Provisional Application No. 61/705,686 filed Sep. 26, 2012 entitled SYSTEM AND METHOD FOR THE CREATION OF ENHANCED AUDIO VISUAL STORYBOARDS USING A LAYERED COMPOSITE IMAGE GENERATOR, U.S. Provisional Application No. 61/716,508 filed Oct. 20, 2012 entitled SYSTEM AND METHOD FOR THE CREATION OF AN ENHANCED MULTI-DIMENSIONAL PICTOGAME, U.S. Provisional Application No. 61/750,022 filed Jan. 8, 2013 entitled SYSTEM AND METHOD FOR THE CREATION OF AN E-ENHANCED MULTI-DIMENSIONAL PICTOKIDS PRESENTATION and U.S. Provisional Application No. 61/763,749 filed Feb. 12, 2013 PAYMENT AND ACCOUNT MANAGEMENT SYSTEM USING PICTOOVERLAY TECHNOLOGY which are hereby incorporated herein by reference in their entireties.

### FIELD OF INVENTION

The present invention relates to a software application system and method for creating an enhanced challenging, informative, educational, competitive, skill-based, Multi-Dimensional PictoGame using the E-Enhanced Multi-Dimensional PictoStory Software Application described in U.S. Provisional Application No. 61/705,686 which is incorporated herein by reference. The Enhanced Multi-Dimensional PictoGame Application Software is partially derived from the PictoStory Software Application by combining and layering multiple static images created within the PictoStory Software Application using PictoOverlay Technology a number of entertainment and educational games are developed. The expansive range of PictoGames may be separated into three general Categories of; 1) Time Killer Games; 2) Parlor Type Games; and 3) Action/Adventure Video Games.

The present invention uses a completely unique approach to develop, structure and present a software application that in a first embodiment is a series of interactive, vibrant computer games that may be played by one or more players on a mobile device, computer, gaming station or other media platforms. An important design feature of the PictoGame Software Application is an Architectural Blueprint that allows a developer to create, order, modify, and playback a series of PictoStorys using PictoOverlay Technology. The PictoStorys are layered composite images that are selected through an application of KeyConcepts to a Basic Idea. The series of PictoStorys may be grouped into Themes based on the Basic Idea providing for an End User to select a PictoGame based on these Themes. The PictoGames are dramatically presented using enhancements that create dynamic audio, video, and sequential effects that challenge and entertain players of the PictoGame.

In a first embodiment, the PictoGame is a PictoPuzzle that displays multiple layered images in a Collage or Decoupage style. These Collage Images are formed from the PictoLayers that make up the PictoStorys. The Collage Image and each PictoLayer are dynamically transformed and arranged through the incorporation of audio, video, slide, animation, interactive features, effects and other media Enhancements. These Enhancements may move, enlarge, shrink, rotate, spin, multiply, and present text, music, narration or other features that entertain and engage an End User to play and attempt to complete a range of Challenges that are presented within the PictoPuzzle. In order to complete the PictoPuzzle, the Challenges may be presented in the form of selecting a correct answer, selecting a correct pictorial image or entering the correct information within a certain period of time thereby removing each PictoLayer to view a Final Image in the form of an identifying image, a trophy, a joke, a high score, or other rewarding displays. Challenges may require the fastest time for completion or highest score individually or with teammates or the best time and score against any number of opponents. The PictoGame may be played on a number of media formats such as personal computers, smartphones, tablet computers, and video gaming environments such as WII, XBox, Play Station and others.

In other embodiments, correct answers to Challenges may construct a pictorial image from the PictoLayers to win and achieve the best time or highest score. Other PictoGames and PictoPuzzles may test hand and eye coordination where a player must search through hostile or adventurous environments to find and destroy specific enemy targets to obtain a best time or highest score. As each Challenge is achieved further levels of complexity are presented to increase the skills of the End User. Using the innovative structural format of the Architectural Blueprint and the series of PictoStorys, the Enhanced Multi-Dimensional PictoGame Software Application provides for an infinite number of PictoGames to be created to entertain, educate, and inform.

### BACKGROUND OF THE INVENTION

Video games for entertainment and education are one of the most prevalent creations in modern society, and while many present diversions to simply kill time others present involved challenging action and adventure through in-depth character creation, sports interaction, seek and destroy missions or other activities. Using known software development techniques and visual and audio effects, characters and environments are painstakingly created to mimic film-like presentation graphics to engage an end user. Similar to a film, the development of the animation within each video game is limited to the included libraries, features and outcomes within the compiled software code to present different more challenging levels for the avid player. Within the video game environment characters, setting or outcomes cannot easily be modified to present a new substantially different element. For example, a new character may not be easily introduced without the interaction of the software developer or user to select and choose from the libraries of available features and then compile and activate the features as a new avatar.

What is not known is the ability to create an infinitely variable video game where new and different elements and activities are chosen from a series of enhanced layered, transparent, composite pictorial images from an infinite broadly categorized library. A structured file naming system and blueprint format provide for the effortlessly incorporation of new and different images and activities within a video game to present further challenges and redirect an outcome of the game. The Enhanced Multi-Dimensional PictoGame Software Application provides for newly presented or newly enhanced games with variable images to be immediately integrated within the PictoGame to present an infinite variety of Games and new and exciting Challenges to an End User.

### BRIEF SUMMARY OF THE INVENTION

The software application system and method of the present invention provides for the development of a large variety of PictoGames that entertain, inform and educate. Each PictoGame presents new strategies and Challenges for an End User as they add, change or remove story sequences and/or layers to reach an ultimate solution and exceed personal best scores or triumph over other opponents. In a first embodiment, the software uses dynamically, enhanced transparent, layered, Collage Images that are made up of PictoStorys that are formed from PictoLayers of Composite Images, Trans-Snips and other features. Enhancements are incorporated to present audio, video, slide, animation, interactive features, effects and other media, to excite and engage the end user as games of chance, trivia, survival and other skill based activities are presented to one player, teams and opponents. The innovative Architectural Blueprint of the Multi-Dimensional PictoGame Application Software provides for PictoLayers of the PictoGame presents a completely different method of development of a software or computer application providing for automatic and immediate modification of features within the application without re-writing or re-compiling of code. New Pictorial Elements and Enhancements seamlessly replace a selected features providing for the display of an infinite series of changing characters, new challenging scenarios, more complex interactive queries and the removal of repetition. Each new challenge increases the skill requirements necessary to match and improve the skill and knowledge of the End User.

All levels of competition may be implored as a PictoGame may be created within three separate categories or types of PictoGames to match the technology requirements of various media formats. The first PictoGame Category of general pastime or Time Killer games includes the PictoPuzzle Games that may be played individually or with teams on a mobile device or personal computer. The second PictoGame Category is the Family Fun Parlor Games where small teams face off against one another in a family fun game board format using a tablet computer or other electronic devices. In these PictoGames, each individual team member has access to the game board to move, respond to Challenges and interact alone or with their teammates to face off against other opponents. PictoGames further provides a third Game Category that require lightning fast skills and physical interaction in a Video Gaming format using gaming devices such as Wii, Xbox, Play Station and others. The PictoGames within each of these PictoGame Categories are broadly based to address a range of skill levels, themes and topics, and contests. The easily interchangeable features of the Collage Images, PictoStory sequences and Challenges and ever increasing skill requirements provides for PictoGames to be well suited to each of these Game Categories. Individuals or teams face off against one or more opponents where the PictoGames be played within video game competitions and tournaments in local settings or in large arenas to truly test the skills and knowledge of each competitor.

### The Enhanced Multi-Dimensional PictoGame Software Modules A, B, C

The Enhanced Multi-Dimensional PictoGame Software Application is comprised of three Modules, A, B and C that design, render, and present the PictoGame. In Module A, an Intro-Explain-Navigate Generator compiles one or more Enhanced Multi-Dimensional PictoStorys using the Architectural Blueprint into a film-like presentation that includes for example an Introduction about the PictoGame, and an Explanation of how to use the PictoGame and a Navigator to explain access to the features to maneuver and use the PictoGame. The Introduction, Explanation, and Navigator are based on the Game Category and a series of Major Themes and Theme Subsets using the Intro-Explain-Navigate Generator.

Using a Blueprint Generator a blank Architectural Blueprint with a Coordinate File Naming System is structured based on the Major Themes and Theme Subsets. The structure of the Architectural Blueprint is unique to each type of PictoGame providing a workspace for the Production Control Tools of Module B to create, enhance, populate and modify the PictoGame. The Production Control Tools of Module B include a Choice Generator that selects the PictoLayers and other Components that will be used in the PictoGame from a Data Store Resource; a Production Populator that locates and positions the selected PictoLayers and their Components on the GameBoard Blueprint; a Random Generator that provides for Alternative PictoLayers and Enhancements to be selected to seamlessly replace one or more Interchangeable PictoLayers of the PictoGame (the replacements may occur while the PictoGame is played); and a Process Controller that develops and activates the actions and process steps that are performed to play the PictoGame.

Module C uses the features of Modules A and B to provide the End User with the Introduction/Explanation/Navigator film-like presentations and activate the controls to play the PictoGame. A review of these presentations and a selection of a Major Theme and Theme Subset allows an End User to rapidly understand and play the PictoGame. Module C further provides navigation, scoring, timing, opponent scoring and timing for one of numerous PictoGames played either individually, with a team or against one or more opponents. Module C also provides synchronized data transfer to and from a local, internet or wireless server to support real-time competitive play with one or more opponents. The PictoGames, within Module C are also properly formatted to display on a variety of electronic systems within a number of media platforms, such as personal computers, mobile devices, video gaming systems, tablet computers and others.

### The Multi-Dimensional Features of the PictoGame Software Application

The Enhanced Multi-Dimensional PictoGame Application Software is described as Multi-Dimensional because Multi-Dimensional refers to the multiple layered Composite Images included within the PictoStorys and layered Collage Images and Enhancements used within the PictoGame where a first dimension, as an example is an attractive Query Enhancement that instructs the End User on the requirements to complete the Challenge presented in a textual format or spoken word. A second dimension may be a static two-dimensional pictorial image that is selected and formatted to form a Trans-Snip on of the Components of a PictoStory. A third dimension may be a layered or Composite 3-dimensional Image formed from a number of layered Trans-Snips. A fourth dimension is the addition of time and sequential relationships using Dynamic HTML, macros and other software scripts to order and display the layered Composite Images to form a PictoStory. A fifth dimension is a layering of multiple Composite Images to form a Collage Image. A sixth dimension is an infinitely variable set of Enhancements that provide action, movement and depth to the Collage Images and the PictoLayers of layered Components and Sub-Components. In point of fact, Enhancements may be seen as extending Collage Images beyond the four normally used dimensions, of X, Y, Z coordinates and time and into many-dimensions to intrigue, entice and captivate an End User playing the PictoGame. Within each dimensional level, a Page is formed that includes access to all of the Components, Sub-Components and Enhancements that are each accessible within the Architectural Blueprint. Each Page provides a Summary and presentation of the Components and Sub-Components that are used to form the PictoLayer which may be a Collage Image, a PictoStory, a Composite Image, or Trans-Snip with Enhancements associated at each of the different dimensional levels.

### Module A

### Intro-Explain-Navigate Generator and Multi-Dimensional Presentations

The Intro-Explain-Navigate Generator of Module A performs two functions: the first is the creation of one or more film-like presentations and controls that provide an Introduction, an Explanation, and a Navigational Instruction about the PictoGame. The Introduction, Explanation and Navigator are based on the Category, type of media platform and strategy of the PictoGame. These Enhanced Multi-Dimensional Presentations are developed from a series of PictoStorys using the Intro-Explain-Navigate Generator and are short, entertaining, and comprehensive instruction to provide a user with all the information necessary to use, play and compete with the PictoGame. The second function of Module A is the structural formation of an Architectural or GameBoard Blueprint using a Blueprint Generator. The GameBoard Blueprint is structured and developed from the Introduction, Explanation, and Navigator developed by the Intro-Explain-Navigate Generator using the series of PictoStorys.

### Module A

### Enhanced Multi-Dimensional Introduction Presentation

In Module A, the Enhanced Multi-Dimensional Introduction Presentation presents the general context of the PictoGame and may include step by step instruction of how the game is played, unique features of the game, and the prize, reward or trophy that is achieved if the game is won. In a first embodiment, the PictoGame may be a PictoPuzzle within the Time Killer Category and the Introduction visually demonstrates that by correctly answering a Challenge a Transparent PictoLayer is peeled off from the Collage Image of the PictoPuzzle revealing more of the PictoLayers below. In further embodiments, a PictoLayer may be added or a combination of adding and subtracting PictoLayers is visually presented with the completion of a final Challenge revealing a trophy, reward, point score, presentation or other feature to successfully show completion of the PictoPuzzle. This short, visually engaging film-like presentation immediately provides to an End User the features and objectives of the PictoPuzzle PictoGame.

### Module A

### Enhanced Multi-Dimensional Explanation Presentation

The Intro-Explain-Navigate Generator also creates an Explanation Presentation from a series of PictoStorys to provide further information on using the control buttons and other system features associated with the PictoGame. The presentation demonstrates, “What the PictoGame Does . . . ”, “How the PictoGame works . . . ” and “What an End User does with the PictoGame . . . ” to clearly and efficiently show the game features so that a novice user may immediately grasp how each feature and control of the PictoGame is used. Each PictoGame may have a series of common control buttons with an additional variety of controls provided for other Categories and different types of PictoGames.

### Module A

### Enhanced Multi-Dimensional Navigator Presentation

The Intro-Explain-Navigate Generator further creates a dynamic Navigation presentation that displays a set of Major Themes and Theme Subsets for the PictoGame, and details the use of the navigation controls. The Navigator is presented using a grouped and structured matrix of rows and columns referred to herein as a Montage. The Montage provides a navigation wall or board for an End User to select and choose the Major Themes and Theme Subsets for the PictoGame. The Montage, for example, may display information in a 3×3 matrix format using three rows and three columns providing nine Major Themes and nine Subset Themes to choose from. The Major Themes and Theme Subsets may be of any content, scope, or range of subject matter with the Major Themes presenting general categories and the Theme Subsets presenting further divisions of Topics, Subjects, and Lessons within the Major Theme.

As a first example, the Major Themes may be; 1. General or Generic Theme that encompasses all other Major Themes; 2. Sports; 3. News and Facts; 4. Music; 5. Film and Television; 6. Hobbies; 7. Art; 8. Travel; 9. Food and Cooking. Each of these Major Themes are then segregated in to the more specific Topics, Subjects and Lessons of as an example, Sports may be subdivided into; 1. General or Generic Theme that encompasses all Sports; 2. Soccer; 3. Hockey; 4. Basketball; 5. Baseball; 6. Tennis; 7. Golf; 8. Volleyball; 9. Skiing The Navigator Presentation visually presents the selection of a Major Theme from the Montage that navigates to and displays the Theme Subsets, where if the Major Theme is Sports then the display may show the selection within the Theme Subsets of Basketball and a PictoGame will be displayed that has a general context that will be related to Basketball. As previously described, the Navigator film-like presentation visually presents to an End User how to select and step through each Major Theme and Theme Subset to select the Topic, Subject Matter or Lesson of interest to begin the PictoGame. The short comprehensive dynamic Multi-Dimensional Introduction, Explanation and Navigation Presentations are a unique feature of the PictoGames that draw in and fully explain to the End User the rewards, features and fun of the PictoGame.

### Module A

### Blueprint Generator and GameBoard Blueprint

A second important function of Module A is the formation and structuring of a blank Architectural Blueprint using the Intro-Explain-Navigate Generator and the Blueprint Generator. The Architectural Blueprint is a completely different approach to the development and activation of a computer game or other software application. Each Architectural Blueprint is unique based on the rules and objectives of the PictoGame and the formation and structure is derived from the Major Themes and Theme Subsets. The Architectural Blueprint is structured as a Referenced Page Map with a grid-like coordinate system to locate and position the number of PictoLayer Pages and their Components and Sub-Components Pages that make up the PictoGame.

### Module B

### PictoGame Production Control Software

Using the Architectural Blueprint, the PictoGame Production Control Software of Module B configures the PictoGame from tens, hundreds or thousands of PictoStorys that form the Collage Images. Layout, format and the relationships between each of the Components and Sub-Components are all structured within the Referenced Page Map of the Architectural Blueprint of the PictoGame creating a work space to create, enhance and modify the PictoGame. The Production Control Tools of Module B include a Choice Generator, a Production Populator, the Random Generator and Production Generator. This completely unique software development and process and control features are used by Production Personal to construct the PictoLayers and their Components and Sub-Components for the PictoGame and to develop the Graphical User Interface (GUI) that includes the control tools, dialog boxes, screen layouts and sequences that the End User sees and operates to play the PictoGame.

### Module B

### Configuration of Data Store Resource

In an initial step, the Data Store Resource is developed with a Coordinate File Naming System that reflects the layered coordinate grid system of the Referenced Page Map of the Architectural Blueprint. In this way the PictoLayers and their Components and Sub-Components of the PictoGame are stored within the Data Store Resource at specific coordinate system locations with file names matching their positions and locations within the Architectural Blueprint. This file naming and storing structure provides for a distinct X, Y and Z coordinate location of each PictoLayer and their Components and Sub-Components for the PictoGame. The X and Y positions are column and row locations within the Referenced Page Map and the Z coordinate refers to the level of the PictoLayer. For example, a Collage Image may be made up of multiple PictoStorys that are formed from multiple layers of Composite Images and Trans-Snips so a first Trans-Snip layer within the Composite Image may have a Z coordinate of 3 referring to the Tran-Snip that is positioned as the third layer in forming the Composite Image. The Trans-Snips and Composite Images of the PictoStorys and Collage Images within the Data Store Resource have been created using the Pictolayer Generator and PictoComposite Generator of the E-Enhanced Multi-Dimensional PictoStory Software Application described in U.S. Provisional Application No. 61/705,686.

### Module B

### PictoGame Production Control Software—Choice Generator

The selection of PictoLayers that may be used in the PictoGame and stored in the Data Store Resource is performed using the Choice Generator. The Choice Generator groups a series of PictoStorys, Composite Images, and Trans-Snips that are within the scope of each Major Theme and Theme Subset. These PictoLayers are stored within a Variable Output Folder within the Data Store Resource. The Variable Output Folder mirrors the Coordinate Filing Naming System of the Architectural Blueprint and selected PictoLayers are stored and renamed using an encrypted code associated with this Blueprint format. Importantly, these PictoLayers have already been categorized and indexed within the Data Store Resource in General Folders related to specific Topics. The Choice Generator scans the General Topic Index and renames selected files using the encrypted code of the Coordinate Filing Naming System thereby developing a library of tens of thousands of PictoLayers that may be used in the PictoGame. PictoLayer that are not used are stored within the Variable Output Folder Alternative PictoLayers that may be used to replace Interchangeable Components and Sub-Components within the PictoGame.

The Choice Generator further structures the PictoLayers within the Major Themes and Theme Subsets into the Montage Pages and creates the Navigation Controls for access to the PictoPuzzles or other PictoGames available within the Theme Subsets. Importantly, for each Major Theme and Theme Subset the Choice Generator compiles from all of the Theme Subsets and from the Alternative Pictolayer Components a General or Generic feature set that includes for example PictoPuzzles from all other Major Themes or from all other Theme Subsets. For example, if the Major Theme was Music and Theme Subsets were; classical, country, rock and roll, jazz, hip hop, salsa, punk, and dance, then the General or Generic Subset includes PictoPuzzles from all genres of music within all of the Theme Subsets. The Choice Generator further creates the graphical user interface (GUI) for the selection of Major Themes and Theme Subsets within the Montage Pages.

### Module B

### PictoGame Production Control Software—Production Populator

The Architectural Blueprint is structured and formatted from Intro-Explain-Navigate Generator of Module A that lays out the Blueprint based on the rules and objectives of the PictoGame. Initially, the Architectural Blueprint is a blank workspace that must be populated from the PictoLayers that have been renamed and indexed by the Choice Generator within the Variable Output Folder. A Referenced Page Map is created within the Architectural Blueprint to provide navigation to all of the PictoLayers and their Components and Sub-Components. The Referenced Page Map does not require scrolling or pull down menus to select and navigate, but instead by zooming out from or in to the Referenced Page Map, the further Components and Sub-Components Pages of each PictoLayer are displayed.

After structuring and formatting the Architectural Blueprint, the Blueprint is populated with the Introduction, Explanation and Navigation Pages. The Montage Pages of the Major Themes and Theme Subsets are also located within the Blueprint. Any number of Major Theme Pages and Theme Subset Pages may be located within the GameBoard Blueprint and saved in the Data Store Resource, creating an infinite variety of PictoPuzzles or other PictoGames from which to choose. Using the Production Populator, the Architectural Blueprint is further populated with selected PictoLayer Pages from the Variable Output Folder to create the Collage Images, skill levels, and features of the PictoGame. Each Page is similarly constructed of PictoStorys that are related to the Major Themes and Theme Subsets and these are located within the Architectural Blueprint at specific locations and are renamed using an encrypted code and are stored within an Output Folder that includes the active Components of the PictoGame. The populated Architectural Blueprint is referred to herein as a GameBoard Blueprint and the layout and file naming structure provides the position and relationship of each of the various PictoLayers and their Components within the GameBoard Blueprint.

The PictoLayers may be Collage Images, PictoStorys, Composite Images, Trans-Snips, Raw Images, or other Components and Sub-Components related to the Major Themes and Theme Subsets. A selected PictoLayer may be used to create other Multi-Dimensional Components. For example, a Trans-Snip may be selected to complete a Composite Image, a Composite Image may be selected to complete a PictoStory, a PictoStory or a Composite Image or Trans-Snip may be selected to complete a Collage Image. PictoStorys may also be modified or created within the Architectural Blueprint where a Basic Idea may be associated with one or more Major Themes and Theme Subsets and the KeyConcepts Query is directed to questions within the scope of the Theme. The Composite Images and Trans-Snips used in the PictoStory may be narrowly tailored to a specific Topic, Subject or Lesson, providing for an opportunity to create Challenges around the specific Topic to educate and inform an End User about that Topic.

### Module B

### PictoGame Production Control Software—Enhancements Generator

Each selected PictoLayer may further be enhanced using the Enhancements Generator to associate action, sound, and visual effects that create the Challenges and functions of the PictoGame. Enhancements, using Dynamic-HTML (D-HTML), subroutines, macros and other coded scripts, vibrantly transform the PictoLayers of the Collage Images. Using the Enhancements Generator and the noted software applications a wide variety of Challenges may be created at each Pictolayer. Dialog boxes, multiple choice check boxes, graphical selection pointers that are selected with movement of the mouse or other device or through the selection of the pointer on a touch screen may all be used to fulfill a Challenge. The Challenge may further require verbal responses, search and identify, or target annihilation using a game controller or other device or numerous other formats to communicate the Challenge requirements and enter a response that may implore a variety of Enhancements. The Enhancement Challenges may be visual, textual, audio, narration, musical, or in any other format that presents a vibrant, engaging query or quest that must be fulfilled by the End User to achieve a next level within the PictoGame. Further a correct response may evoke visual or audio Enhancements that acknowledge the achievement. For example, the sound of applause may play whenever a challenge is correctly fulfilled. Enhancements may also be associated with the Collage Image or any Component or Sub-Components of a PictoLayer to sequentially order or re-order, add background-music, audio and visual effects, movement, and other features of the PictoLayer. For example a Composite Image or Trans-Snip layer first appearing on top may be re-ordered to move to the bottom if a Challenge is incorrectly fulfilled.

### Module B

### PictoGame Production Control Software—Random Generator

Particularly, within the PictoPuzzle, PictoGame, a Random Generator within the PictoGame Production Control Tools may provide for the Collage Images, PictoStorys, Composite Images and Trans-Snips and other PictoLayers and Enhancements to be automatically replaced with Alternative PictoLayers. The Alternative PictoLayers are selected from the categorized and indexed PictoLayers within the Variable Output Folder of the Data Store Resource based on the Main Themes and Theme Subsets. A correct response or incorrect response may cause the random selection of an Alternative PictoLayer or a transition to an Alternative Enhancement that presents a new Challenge. The replacement is seamless where the Interchangeable PictoLayer or Enhancement within the Collage Image is immediately replaced by accessing and re-naming the Alternative PictoLayer with the encrypted coordinate file name matching the grid position of the Interchangeable PictoLayer within the GameBoard Blueprint and moving the Alternative PictoLayer into the Output File Folder. The Collage Image is immediately changed and Enhancements associated with the Alternative PictoLayer are immediately activated and accessible to the End User.

This automatic immediate replacement of PictoLayer also replaces all of the Components and Sub-Component associated with the PictoLayer without the re-writing of code or recompiling of the Enhanced PictoGame Software Application. This efficient and seamless replacement provides for an infinite set of PictoLayers and Enhancement Challenges to be presented within a series of PictoPuzzles. The new Challenges may be more difficult to improve the End User's skill level or completely change the Challenge requirements, so that new skills may be adapted. The Alternative PictoLayers and Enhancements may replace an Interchangeable PictoLayer at any time before, during or after the play of the game continually introducing new features and preventing an End User from seeing the same Challenge more than once. In further embodiments, the same PictoLayer may be used more than once but be associated with a new Enhancement Challenge.

### Module B

### PictoGame Production Control Software—Process Control System Tools

After categorizing and indexing the PictoLayers, populating the GameBoard Blueprint, and configuring for Alternative PictoLayers that may be used within the PictoPuzzle or other PictoGame, the Process Control System Tools are developed for the End User to manipulate, control and play the PictoGame. The Process Controller within Module B configures the interaction required by the End User to complete each Challenge, structure the levels of progression for the completion or failure of each Challenge, determine the scoring and time lapsed requirements and set the requirements for completion or winning of the PictoGame.

In a first embodiment the PictoGame may be a PictoPuzzle and the Process Controller would determine steps and controls necessary to for example peel off a PictoLayer such as by using a mouse or other control device to select a portion of the image in responding to a Challenge. A correct selection would remove the PictoLayer and reveal all or more of the PictoLayers beneath. In other examples, the Process Controller may activate the addition of layers, or alternate between the addition and removal of PictoLayers as Challenges are met or as Opponents competitively interact with the PictoGame. With Enhancements and the Multi-Dimensional PictoLayers forming the Collage Images from many PictoStorys and their Components and Sub-Components numerous actions and activities may be incorporated using the Process Controller. Within the Architectural or GameBoard Blueprint, the Process Control System Tools perform all of the steps necessary to create, arrange, modify, enhance, and edit the PictoLayers and activate the PictoGame for the features within Module C to present the PictoGame to the End User.

### Module C

### The PictoGame Presenters

The PictoGame Presenters of Module C display to the End User all of the features for an End User to enter a handle or user name for identification and enter a password to login and play or download the PictoGames from, for example, a website through an internet connection. Alternatively, using features within Module C, certain genres of PictoGames may be installed to a personal computer system, a mobile or electronic device or a video gaming station for access. The PictoGame Presenters further provide connections to an intranet or internet server to provide for competitive matches between more than one computer system, mobile device or video gaming station for competitive play and ranking of scores for an individual or for team play against one or more opponents. PictoGame competitions may further be well suited for Video Game Tournaments and Competitions held within gaming arenas with a number of players competing for a prize. Other access features and embodiments for accessing and playing the PictoGame are within the scope of the present invention.

Module C further generates, displays and maintains all statistics and scoring for each individual player, teams and opponents including win/loss records and highest scores. Displays and control buttons provide access to the PictoGame Title and PictoGame Number and features such as; Start, Stop, Pause, Activate, Show Time Elapsed, Show Score, Show Team Score, Show Opponents Score, and other general features that may be used and applied in many different PictoGames. Access to Help Information and control buttons to send the PictoGame to a server or retrieve information on the PictoGame from the server are also available. New PictoGames may also be downloaded using the Module C control features.

### Module C

### End User Application Software

The End User Application Software displays the Introduction Presentation to the End User showing an overview and the exciting features of the PictoGame. The Explanation Presentation is also provided to visually and succinctly give instructions on how to play the PictoGame. The Navigator Presentation provides information on stepping through and accessing the Main Themes and Theme Subsets of the PictoGame. After the optional review of these presentations, for the End User is presented with the Major Theme Montage Page in a first embodiment as a 3×3 matrix of Collage Image Pages representing each Major Theme. Selecting a page within the Main Theme opens another 3×3 matrix format Montage Page for the Theme Subsets. Each Main Theme and Theme Subset includes the General or Generic Theme Page that encompasses topics from all other Themes. In selecting this Generic Page a PictoGame that includes pictorial elements from all of the other topics within the Main Themes or within the other Theme Subsets is presented. Control Buttons around the Montage may provide access to present additional Montages or move back or forth through displayed Montages.

Selecting a Theme Subset Page displays a series of PictoGames related to Topics, Subjects and/or Lessons within Theme. In a first embodiment, the PictoGame may be a PictoPuzzle where a Collage Image of the PictoPuzzle displays pictorial elements related to the Theme Subset or all Theme Subsets if the Generic Theme Page is selected. The End User Application Software displays a set of controls to layer and/or delayer the PictoPuzzle or perform a combination of both steps of layering and de-layering within the PictoLayers depending upon the requirements of the Challenges of the PictoPuzzle. Enhancements associated with the PictoLayers display dialog boxes or multiple choice check boxes or other forms of data entry for the End User to input and respond to Challenge questions such as; Who is pictured in the Collage Image?, as an example. A correct entry de-layers the Collage Image by removing the PictoLayer of a PictoStory, Composite Image or Trans-Snip layer and all or a greater portion of the Collage Image layers below are revealed. In a further embodiment, a picture of a person may be partially revealed and correctly responding in a dialog box may add layers to the Collage Image to complete the picture of the person so that identification of the person may be made to correctly fulfill a challenge or complete the PictoPuzzle. Points may be given for each completed Challenge of layering or de-layering or the time to complete the PictoPuzzle or PictoGame may be recorded with points awarded for the number of completed Challenges and fastest times for example.

In further embodiments, using the End User Application Software and Enhancements, the End User may select or point to a portion of the Collage Image to indicate a location within the Collage Image to fulfill the challenge or select a particular PictoLayer from a series of Composite Images or Trans-Snip layers to add to the Collage Image or be removed from the Collage Image. As an example, the Challenge may present a person's name within a dialog box and by selecting that person's facial image from the display of a multitude of facial images within the Collage Image the Challenge is fulfilled and the layer is removed from the Collage Image. The selection may be made using a pointer device such as mouse, be selected on a touch screen or be indicated using a game controller for example. The removal of the layer reveals the layers below and another Challenge to the End User is presented. Enhancements associated with the PictoLayers at the Collage Image level, the Composite Image level, the Trans-Snips level, and/or the complete PictoPuzzle provide numerous methodologies to present queries and activities to request information and have the End User interact with the PictoPuzzle or other PictoGame to fulfill the Challenges.

PictoPuzzles or other PictoGames may further combine the layering and delayering in an elaborate competitive action game against one or more components where using enhancements PictoLayer become targets that are removed or added as the End User moves through situational events or dynamic Challenges to complete a mission and receive a high score or best time for a victory within a competitive match. Using Enhancements, each PictoLayer is dynamically transformed creating sequential and non-sequential events, to add text or spoken word, to add audio effects, add video effects, to perform zooming, spinning, or other graphical effects and features to present numerous Challenges and strategies for PictoPuzzles and other PictoGames within the scope of this invention. The Challenge strategies for PictoPuzzle and the types of PictoGames may be in any format to entertain, inform and educate where information is displayed in a Multi-Dimensional Film-like Presentation and then critical thinking Challenges may be presented to require input from the user to select or describe the information to show and prove understanding of the information.

To further engage and provide a competitive element that allows even a poor scoring End User to still have a chance to win the PictoGame, an important feature of Module C is access to a “Kill Them” or “Annihilate Them” Challenge Button that presents a high risk Challenge. For example, in a highly contested match or in a match where an End User has no chance of success because of a wide difference in scores, by selecting the Annihilate Them Button a risk verse reward score or time advantage is presented that allows the End User to receive a much larger score than normally available within the PictoGame scoring parameters. By fulfilling the Challenge, the End User receives the reward which may be a higher score or reduction in elapsed time, or a reduction in the opponent's score or increase in elapsed time. The Annihilate Them Button Challenge is much more difficult than Challenges presented on a comparable level of difficulty within the PictoGame and therefore if successful there is a greater reward. However if unsuccessful, the End User's score or the End User's elapsed time is detrimentally effected with a much larger loss than the amount of reward and larger than any normal scoring loss or time lapsed parameters within the PictoGame. The Annihilate Them Button option may be available at any time during the PictoGame or at specific times based on scores or current Challenges or other parameters to keep the PictoGame at a competitive level.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the Components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### Some of the Objects of the Invention

An object of the invention is to provide a software platform on a computer system that creates an Enhanced Multi-Dimensional PictoGame using dimensionally layered, displayable, Collage Images and Sequenced PictoStorys associated with a series of Challenges that entertain, engage and test the skills of an End User.

Another object of the invention is the development of the PictoGame using PictoStory Technology and the innovative Architectural Blueprint design work space to create, edit, modify and present the features and controls of the PictoGame.

Another object of the invention is the development of the PictoGames on various media formats such as mobile devices, personal computers and video gaming stations to have an End User pass the time, competitively play with teams and opponents, and to dynamically interact with the features and Challenges of the PictoGame.

Another object of the invention is the creation of a series of dynamic, enhanced, overlaid visually ‘Show not Tell’ presentation using the PictoStory Technology to quickly and comprehensively show an End User features, controls and navigation of the PictoGame so that the End User may immediately grasp the requirements and begin playing the PictoGame.

Another object of the invention is the use of the Architectural Blueprint to develop a series of Major Themes and Theme Subsets to allow an End User to choose the topics, subjects or lessons provided within the PictoGame.

Another object of the invention is the structure and formatting of an Architectural Blueprint with a Multilevel Reference Coordinate System and developing an encrypted file naming structure that reflects the Multilevel Reference Coordinate System.

Another object of the invention is to acquire and process one or more Components or Sub-Components or Raw Images using a PictoLayer Generator by shaping, cropping from any portion of the Component, Sub-Component, or Raw Image, and sizing and locating on a transparent blank to form a PictoLayer that may be a Trans-Snip, Composite Image, PictoStory, Collage Image or other Component of the PictoGame.

Another object of the invention is to integrate audio, video, text, pictorial and non-pictorial Enhancements to the PictoLayers at any level such as to a Trans-Snip, a layered Composite Image, a group of layered Composite Images, a PictoStory, a Composite Image or at a presentation level to engage, entertain, educate, and Challenge the End User with the features of the Enhanced Multi-Dimensional PictoGame.

Another object of the invention is a Coordinate File Naming System based on the Multilevel Reference Coordinate System of the Architectural or GameBoard Blueprint to store and access PictoLayers formed from the Components and Sub-Components using the PictoLayer Generator.

Another object of the invention is the categorization and indexing of Components and Sub-Components based on the Major Themes and Theme Subsets and renaming and storing these PictoLayers using a Choice Generator within a Data Store Resource for use within the PictoGame.

Another object of the invention is using the renamed and stored PictoLayers to populate the Architectural Blueprint using the Production Populator in the PictoGame Production Control Software.

Another object of the invention is the seamless replacement of Interchangeable PictoLayers with Alternative PictoLayers using the Encrypted Coordinate File Naming System based on the Multilevel Reference Coordinate System of the Architectural or GameBoard Blueprint. The replacements may be specific or random and may be performed while playing the PictoGame.

Another object of the invention is the use of Process Controllers in the PictoGame Production Control Software to create, navigate, order, modify, enhance, edit, playback, review, combine, render, realize and activate the PictoLayers and activate the PictoGame within the Architectural or GameBoard Blueprint.

Another object of the invention is the layering or de-layering or combination of Layering and de-layering of PictoLayers through the attempts and completion of Enhanced Challenges to play, compete and win or lose the PictoGame.

Another object of the invention is the tracking of timing, scoring, win/loss, record, highest score, fastest time, competitors time and score, teammates time and score and other statistical data based on the requirements and Challenges of the PictoGame.

Another object of the invention is the formatting and presentation of the PictoGame on a mobile device for passing the time.

Another object of the invention is the formatting and presentation of the PictoGame on a tablet computer or electronic device that serves as a game board for one or more players in a family fun, friendly game night pass time.

Another object of the invention is the formatting and presentation of the PictoGame on a video gaming station.

Another object of the invention is competitively playing the PictoGame with teammates or opponents through an intranet or internet connection in real time.

A still further object of the invention is the accessing or downloading of one or more PictoGames to a personal computer, mobile device, electronic device, video gaming station, or other system to play and compete individually, in teams and/or against opponents.

The present invention is related to a software system for the creation of an enhanced multi-dimensional pictogame, comprising application software installed on a computer system, the application software further comprising a choice generator, a pictolayer generator, a pictocomposite generator, an enhancements generator, and a game board blueprint, and wherein a plurality of pictolayers are formed from at least one raw image using the pictolayer generator, the plurality of pictolayers are layered using the pictocomposite generator to form a pictopuzzle, the pictopuzzle is located within the game board blueprint and enhanced using the enhancements generator, a plurality of challenges are associated with the pictopuzzle, and the completion of at least one of the plurality of challenges results in a modification to the pictopuzzle and a score in an enhanced multi-dimensional pictogame. In the software system for the creation of an enhanced multi-dimensional pictogame the plurality of pictolayers are one of at least a trans-snip, a composite image and a pictostory. Also in the software system for the creation of an enhanced multi-dimensional pictogame the completion of a challenge results in the adding of a pictolayer to the pictopuzzle, the removal of a pictolayer from the pictopuzzle or in the addition and removal of at least one pictolayer. A dialog box for data entry may further be presented in at least one challenge from the plurality of challenges.

The software system for the creation of an enhanced multi-dimensional pictogame further includes a random generator for the replacement of a pictolayer with an alternative pictolayer and the presentation of one of at least an introduction presentation, an explanation presentation and a navigation presentation about the enhanced multi-dimensional pictogame. In the software system for the creation of an enhanced multi-dimensional pictogame the choice generator selects from a plurality of pictolayers related to a theme and renames one of the plurality of pictolayers with a coordinate file name matching a coordinate of the game board blueprint to include in the pictopuzzle. The coordinate file name may be encrypted. The software system for the creation of an enhanced multi-dimensional pictogame further comprises a production presenter for the presentation of the pictopuzzle and enhanced multi-dimensional pictogame in a media format for display on one of at least a cellular phone, a smartphone, a tablet computer, and a computer monitor.

The present invention is also related to a method of creating a pictorial game, comprising the steps of accessing application software installed on a computer system, selecting a series of themes and theme subsets, forming at least one pictolayer related to one of the themes and theme subsets, selecting a plurality of pictolayers related to one of the themes and theme subsets, creating at least one pictopuzzle from the plurality of pictolayers related to at least one of the series of themes and theme subsets, associating at least one enhancement with one of at least the plurality of pictolayers and at least one pictopuzzle, developing a plurality of challenges related to the series of themes and theme subsets, completing at least one challenge from the plurality of challenges, recording a score for the completion of a challenge, and modifying the pictopuzzle. The method of creating a pictorial game also comprises the steps of modifying the pictopuzzle by adding at least one pictolayer to at least one pictopuzzle or by removing at least one pictolayer from the pictopuzzle or by adding at least one pictolayer and removing at least one pictolayer from the pictopuzzle or creating at least one dialog box for the entry of data to complete at least one challenge from the plurality of challenges while playing the pictorial game.

The method of creating a pictorial game further comprises the steps of replacing at least one pictolayer from the plurality of pictolayers with an alternative pictolayer within the pictopuzzle while playing the pictorial game and of presenting one of at least a comprehensive introduction presentation, explanation presentation and navigation presentation about the pictorial game. The method of creating a pictorial game further comprises the steps of formatting the pictorial game to be presented for display on one of at least a cellular phone, a smartphone, a tablet computer, and a computer monitor.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating a first embodiment of the Modules A, B, and C that in a first embodiment make up the enhanced Multi-Dimensional PictoGame Application Software of the present invention.

FIG. 2 is a block diagram of a first embodiment of the computer platform of the Enhanced Multi-Dimensional PictoGame Application Software of the present invention.

FIG. 3 is a block diagram representation of a first embodiment of the components of the Intro-Explain-Generator of Module A of a first embodiment of the present invention.

FIG. 4 is a block diagram representation of a first embodiment of the components of a Theme Subset Montage Page of Module A of a first embodiment of the present invention.

FIG. 5 is illustrative representation of a first embodiment of an Architectural Blueprint Transparent Formatted Page Cell Map of a first embodiment of the present invention.

FIG. 6 is a diagrammatic representation of a first embodiment of the formation of a Collage Image of a first embodiment of the present invention.

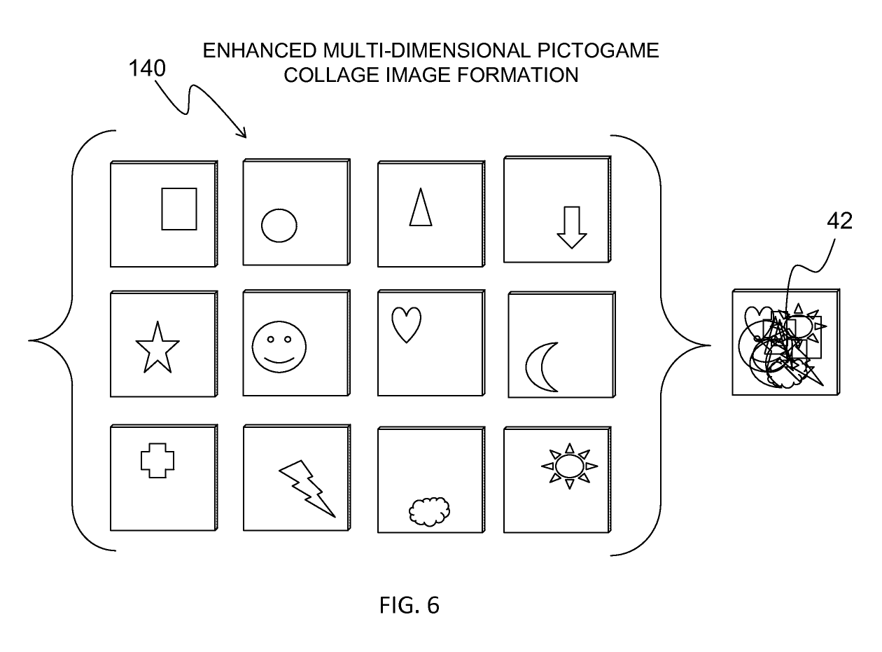

FIGS. 7A-7D are diagrammatic representations of a first embodiment of the operation of the PictoLayer Generator in selecting a Pictorial Element from a Raw Image of a first embodiment of the present invention.

FIG. 8 is an illustrative representation of a first embodiment of a Trans-Snip Layer Page in a first embodiment of the present invention.

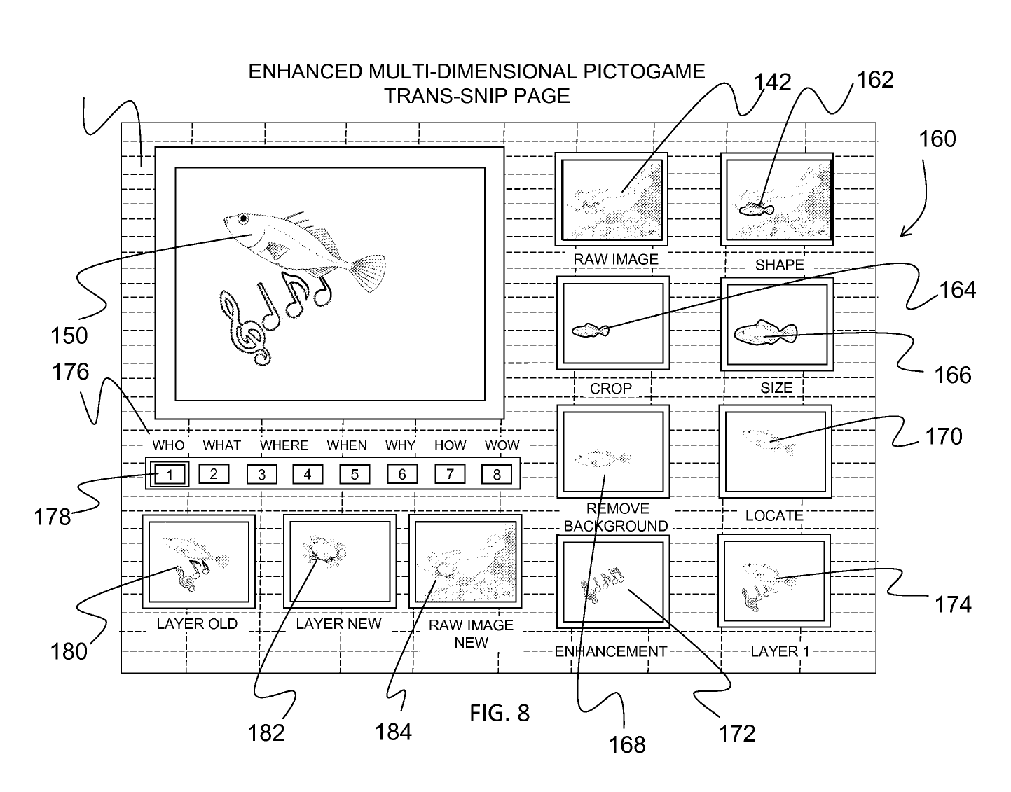

FIG. 9 is a diagrammatic representation of a first embodiment of a partial overlay of a group of Trans-Snip Layers in forming a Composite Image in a first embodiment of the present invention.

FIG. 10 is a diagrammatic representation of a first embodiment of a layered Composite Image in a first embodiment of the present invention.

FIG. 11 is an illustrative representation of a first embodiment of a layered Composite Image Page of a first embodiment of the present invention.

FIG. 12 is a diagrammatic representation of a first embodiment of a PictoStory Page in a first embodiment of the present invention.

FIGS. 13A-13F are diagrammatic representations of a first embodiment of a PictoPuzzle where PictoLayers are progressively removed as each Challenge is completed in a first embodiment of a PictoGame of the present invention.

FIG. 14 is a diagrammatic representation of a first embodiment of a PictoPuzzle with a Collage Image and Challenge in a first embodiment of a PictoGame of the present invention.

FIGS. 15A-15B are diagrammatic representations of a further embodiment of a PictoPuzzle where an overlaid PictoLayer is removed using Enhancements to complete a Challenge in a further embodiment of a PictoGame of the present invention.

FIGS. 16A-16F are diagrammatic representations of a further embodiment of a PictoPuzzle where PictoLayers are progressively added as each Challenge is completed in a further embodiment of a PictoGame of the present invention.

FIGS. 17A-17I are diagrammatic representations of a further embodiment of a PictoPuzzle where PictoLayers are added and removed as each Challenge is completed in a further embodiment of a PictoGame of the present invention.

FIGS. 18A-18D is a diagrammatic representation of a first embodiment of a seamless replacement of an Interchangeable PictoLayer with an Alternative PictoLayer in a Collage Image in a first embodiment of the present invention.

FIGS. 19A and 19B are illustrative representations of a first embodiment of a replacement of an Interchangeable PictoLayer within a Collage Image of PictoPuzzle in a first embodiment of PictoGame of the present invention.

FIGS. 20A and 20B are illustrative representations of a first embodiment of a solution of a PictoPuzzle in a first embodiment of PictoGame of the present invention.

FIG. 21 is an illustrative representation of a first embodiment of the Production Presenter in a first embodiment of PictoGame of the present invention.

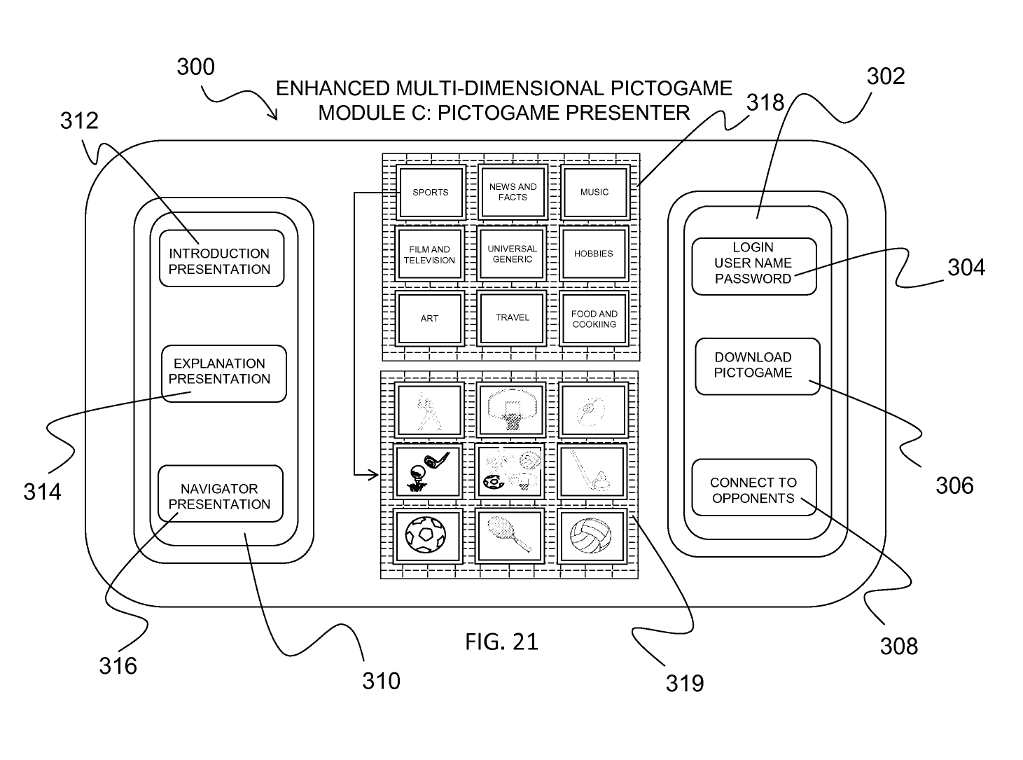

FIG. 22 is an illustrative representation of a first embodiment of the End User Software Application in a first embodiment of PictoGame of the present invention.

### DETAILED DESCRIPTION OF THE INVENTION

Turning now descriptively to the drawings, in which similar reference characters denote similar elements throughout the several views, the figures illustrate the Enhanced Multi-Dimensional PictoGame Application Software that uses Collage Images formed from a series of Enhanced Sequenced PictoStorys that create challenging, infinitely variable PictoGames to be played on personal computers, mobile devices, tablet computers, electronic devices, video gaming stations and other computer and electronic systems.

### Details of the Enhanced Multi-Dimensional PictoGame Software Modules

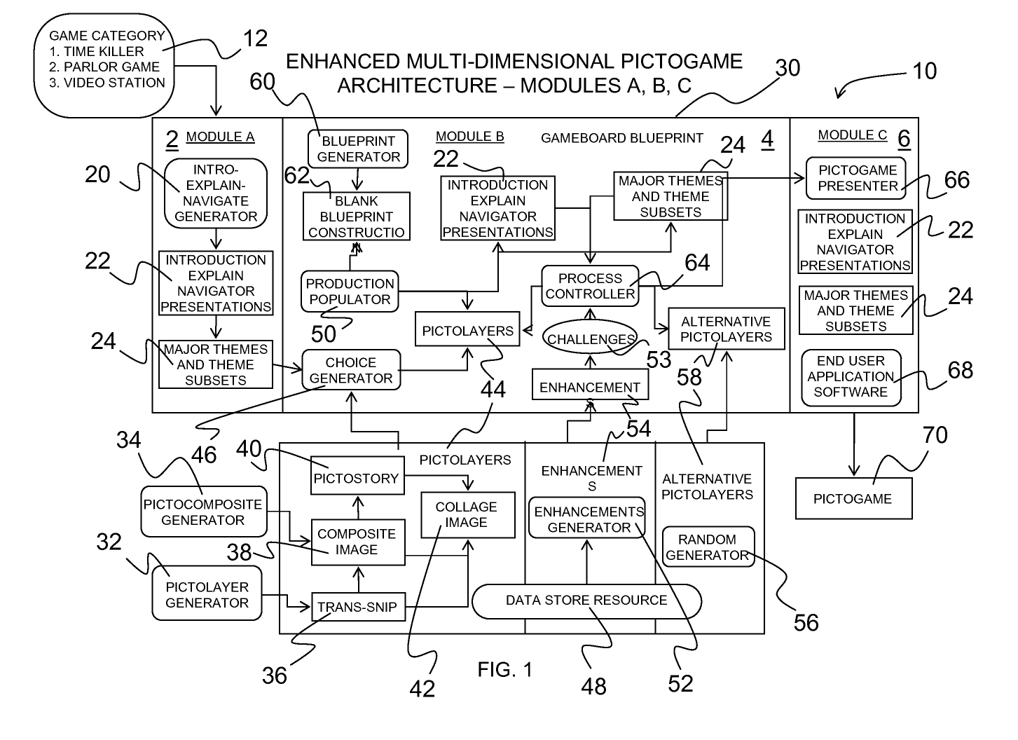

As shown in FIG. 1, the Enhanced Multi-Dimensional PictoGame Software Application 10 may be presented is a number of media formats 12 that are referred to herein as a Time Killer format for mobile device, a Parlor Game format for tablet computers and other electronic devices and in a video station game format for use on interactive video game platforms such as Wii, X-Box, and Play Station among other. The Enhanced Multi-Dimensional PictoGame Software Application 10 is comprised of three Modules, A, B and C that design, populate, and present the PictoGame. In Module A indicated as 2, an Intro-Explain-Navigate Generator 20 creates a series of Presentations 22 to inform and instruct the End User on the PictoGame features, how to play, and how to access the controls of the PictoGame by displaying an Introduction, an Explanation and a Navigation Presentation. Module A also structures a series of Major Themes and Theme Subsets 24 that provides the themes and context for the topics, subjects and lessons of thousands of PictoGames that may be accessed through the Major Themes and Theme Subsets Montage Pages.

The Introduction, Explanation and Navigation Presentations 22 and the Major Themes and Theme Subsets 24 are used to develop the format and structure of a Blank Architectural Blueprint 62 using the Blueprint Generator 60. The Major Themes and Theme Subsets 24 are also used by the Choice Generator 50 to scan and select Trans-Snips 36, Composite Image 38 and PictoStorys 40 that are related to the Major Themes and Theme Subsets 24. These PictoLayers 44 have been created using the PictoLayer Generator 32 and the Composite Image Generator 34. The PictoLayers 44 are used to create Collage Images 42 that are formed by layering multiple PictoLayers 44. The Choice Generator 50 uses an encrypted renaming format and stores the selected PictoLayers 44 into a Variable Output Folder (not shown) in the Data Store Resource 48 for use within the PictoGame 70.

Using the Production Populator 50 of Module B, the Introduction, Explanation and Navigation Presentations 22 and the Major Themes and Theme Subsets 24 are first selected to populate the GameBoard Blueprint 30. The PictoLayers 44 stored within the Variable Output Folder are then selected and used to populate the Architectural Blueprint forming a GameBoard Blueprint 30 that creates a workspace for the construction and modification of the PictoGame 70. The PictoLayers 44 are further associated with Enhancements 54 using the Enhancements Generator 52 and Process Controller 64 of the PictoGame Production Tools 27 to create dynamic features and the Challenges 57 that must be completed to win the PictoGame 70. Module B also includes a Random Generator 56 that selects Alternative PictoLayers 58 to replace PictoLayers 44 within for example the PictoPuzzle PictoGame 70. Any style of PictoLayer 44 may have alternatives for replacement, for example any Trans-Snip 36, Composite Image 38 or PictoStory 40 may be replaced with an Alternative PictoLayer 58 of a similar type using the Random Generator 56.

The PictoGame 70 is constructed within Module B and is then presented in Module C using the PictoGame Presenter 66. The Introduction, Explanation and Navigation Presentations 22 are first presented to the End User to provide an overview, instruction and navigation for using the PictoGame in a comprehensive, succinct, dynamic pictorial presentation to engage the End User and inform them of all of the PictoGame 70 features. The Major Themes and Theme Subsets 24 are then presented for the End User to select the Topics, Subject and Lessons for the PictoGame 70. The End User Application Software 68 presents the Collage Images and controls for the End User to play and compete in the PictoGame 70.

### Application Software Computer Platform

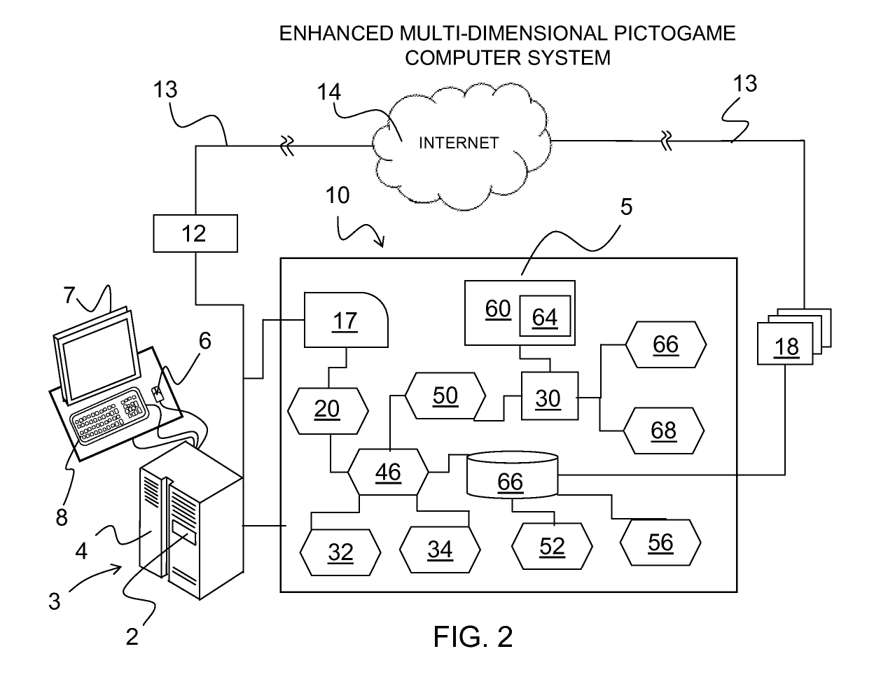

As shown in FIG. 2, in a first embodiment the Enhanced Multi-Dimensional PictoGame Application Software may be implemented in computer hardware and computerized equipment. For example, the method can be performed using a system including one or more digital communications devices and/or one or more personal computers and data servers. Although the computer system 3 is shown for the purpose of illustrating a preferred embodiment, the present invention is not limited to the computer system 3 shown, but may be used with any electronic data processing system such as found in personal or other digital communications devices, cellular phones and other mobile devices, home computers, tablet computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the processor unit 5 for displaying user-related information associated with the software, e.g., by means of a graphical user interface. A keyboard 8 may also be connected to the processor unit 5 for permitting a user to input information to a software program. As an alternative to using the keyboard 8 for input, a mouse 6 may be used for moving a selector on the display 7 and graphical user interface, or alternatively a touch screen input device may be provided for selecting an item and providing input to the processor 5. It is to be appreciated that the input is not limited to the known input apparatus and methods but includes input methods and devices which may yet be developed.

Memory and data storage, in any form, can be included and is illustrated as a hard-disk device such as computer readable storage medium 2, which can include software programs, and is connected to the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area network, such as the Internet. Still further, the processor unit 5 may be programmed, as is well known in the art, for storing the software program internally. A printer or other output device can also be connected to the processor unit 5 for printing a hardcopy of the display from the computer system. The processor unit 5 can have a network connection 13, such as a telephone line, network cable or wireless link, to an external network, such as a local area network or the Internet 14.

The output device 7 provides visually to the user transactional, interactive or variable data that has been Subject to transformations. The output device 7 can be a monitor or other visual computer screen or graphical user interface (GUI), a printer or other output device that provides a visual or other representation of a final output from the processor unit 5. The output device 7 can also be an output device that provides the transactional data as a digital file. The processor unit 5 provides means for processing the transactional, interactive or variable data to produce readily discernible, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions.

The server computer 4 can store a computer program product having a program stored in the computer readable storage medium 2, which may include, for example: magnetic storage media such as a magnetic disk or magnetic tape; optical storage media such as an optical disc, optical tape, or machine readable bar code; solid state electronic storage devices such as random access memory (RAM), read only memory (ROM) or flash memory data storage devices. The associated computer program and data server may be implemented through application software 17 on a SaaS (Software as a Service) or on demand computing service such as a Cloud or shared resource database through a web browser. A secure login with password may be provided to remotely access the software 17 through an intranet or internet connection. One or more of the devices to access the application software may be connected wirelessly, such as by a cellular link, either directly or via a network. It is to be appreciated that such devices can be mobile devices (e.g., camera, PDA, iPod, iPad, tablet computer or cell phone that can be used as a processing unit, a display unit, or a unit to give processing instructions), and as a service offered via the World Wide Web.

In each context, the invention may stand alone or may be a component of a larger system solution. Furthermore, human interfaces, e.g., the input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject a result, or may be assisted by data or metadata (data or metadata that may be user supplied, supplied by another computer program or database from a different application or determined by an algorithm). Moreover, the algorithm(s) may interface with a variety of workflow user interface schemes.

In the following description, some features are described as “software” or “software programs”. Those skilled in the art will recognize that the equivalent of such software can also be readily constructed in hardware. Because data manipulation algorithms and systems are well known, the present description emphasizes algorithms and features forming part of, or cooperating more directly with the method and hardware of the presently disclosed invention. General features of databases, digital communications devices, email and computerized systems are likewise well known, and the present description is generally limited to those aspects directly related to the method and related hardware of the invention. Implementation of the present invention may be in conjunction with one or more database management systems (DBMS) such as Oracle, IBM DB2, Microsoft SQL Server, PostageSQL, MySQL, or others using widely supported database languages such as SQL to define and manipulate data and perform data queries. Other aspects of such algorithms and apparatus, and hardware and/or software for producing and otherwise processing the data involved therewith, not specifically shown or described herein may be selected from any such systems, algorithms, Components, and Elements known in the art. The present invention may further be implemented on a secure web server 9 using SSL, SHTTP or other security protocols for encryption and decryption of transmitted data. Data replication and redundancy is performed automatically and all servers are secured in optimal conditions. Further security is provided where each story project is setup using a unique domain name that is accessible only using login identifications and passwords. User logins and preferences link specific user information to their user identification to provide predetermined access to information for each user. Administrative tools within the application software 17 monitor, add or remove users, manage content and set restrictive/predetermined access parameters to users of the system. In developing PictoGames 70 on different platforms and media formats, the PictoGame Application Software provides access to download the PictoGame through an app to a mobile device or through an internet connection to install and/or play the PictoGame on a personal computer or other electronic device.

### Details of Module A

### The Intro-Explain-Navigate Generator

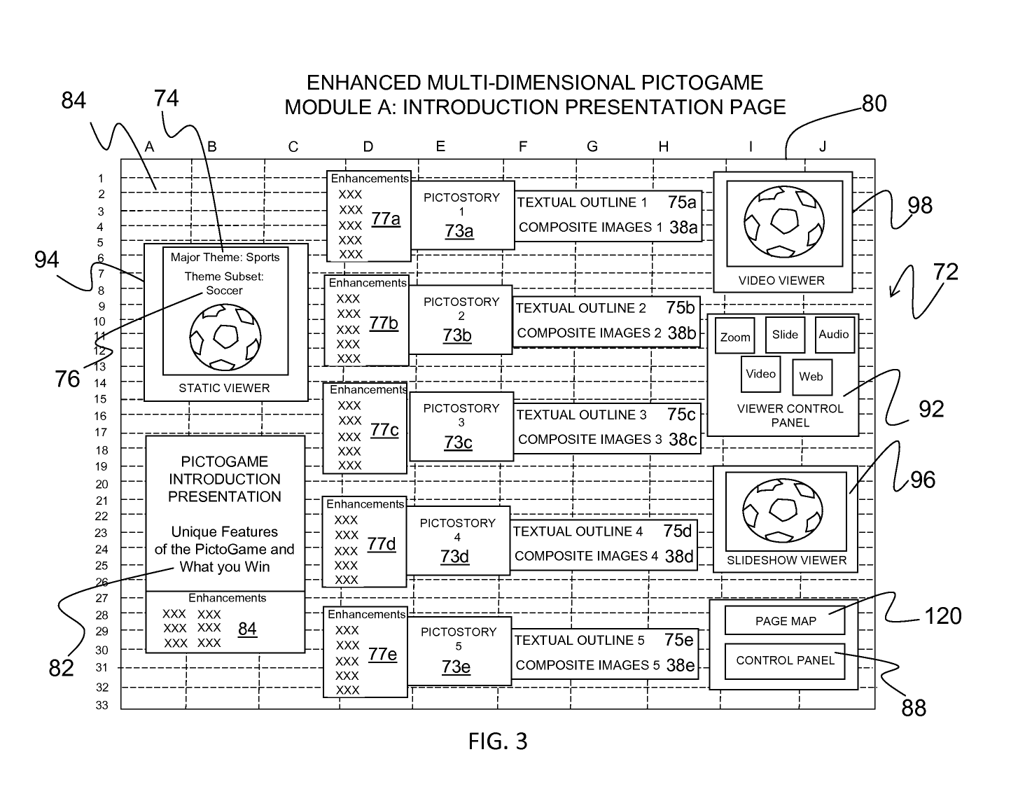

A PictoGame 70 is developed using the Intro-Explain-Navigate Generator to create a set of pictorial presentations that immediately convey the unique features of the PictoGame explain how to play the game and provides instructions on navigating and selecting a Major Theme and Theme Subset to choose from thousands of PictoGames. The presentations are created from a series of Enhanced PictoStorys that are structured and formatted within an Architectural Blueprint 80 as shown in FIG. 3. The Introduction Presentation Page 72 is constructed around a Major Theme 74, in this example Sports and a Theme Subset 76 or Topic, Soccer.

A PictoStory 73 is formed from layered Composite Images 38 derived from an expanded Textual Outline 75 related to the Theme Subset 76. In this example a series of five PictoStorys 73A-73E are associated with one or more Enhancements 77A-77E to order and present the PictoStorys 73A-73E sequentially in the film-like Introduction Presentation. A Summary PictoStory 82 is also created to provide a brief outline and overview of the Introduction Presentation of the PictoGame 70. The Introduction Presentation Page 72 has a Referenced Cell Map 84 for the association of the PictoLayers for each of the PictoStorys 73A-73E, the Summary PictoStory 82 and other Components of the Presentation 72. The Architectural Blueprint also provides Production Control Tools 27 to create and edit the Presentation 72 s. A Control Panel 88 provides access to the Production Tools 27 and a Referenced Page Map 120 that provides a navigator to access all of the PictoLayers 44 and Components and Sub-Components of the Presentation 72. The PictoGame Presenter 92 features a group of controls to add audio and video effects to view the Presentation 72 and a series of viewers provide for viewing the Presentation 72, statically 94 as a slideshow 96, or in a film-like manner 98.

An Explanation Presentation and Navigation Presentation are similarly created using the Intro-Explain-Navigate Generator 20 and Architectural Blueprint 80. The Introduction, Explanation and Navigation Presentations are each placed within the GameBoard Blueprint to be activated using Production Control Tools 27 of Module B. Each Presentation Page is structured with a location and coordinate file corresponding to a position within the Referenced Page Map 120 of the GameBoard Blueprint. The Presentations are also renamed with this coordinate position and stored in the Output Folder of the Data Store Resource 48.

As an example for the Introduction, Explanation and Navigation Presentations for a PictoPuzzle, the Introduction Presentation may show a rapid playing of the PictoGame, with Challenges 57 being presented and PictoLayers being removed revealing the secret image or other trophy after the PictoPuzzle is solved. The Explanation may pictorially show a pointer device or mouse selecting each control and demonstrating the function and the Navigation Presentation may show the selection of a PictoPuzzle from Major Theme and then Theme Subset Montage Pages 100 representing the context of the PictoPuzzle. For example, a Major Theme of Entertainment may have a Theme Subset of Movies and a group of PictoPuzzles all related to the movies may be presented where some PictoPuzzles may be related to a specific movie, or the PictoPuzzle may be related to a number of famous actors within a number of movies.

### Details of Module A

### Major Theme and Theme Subset

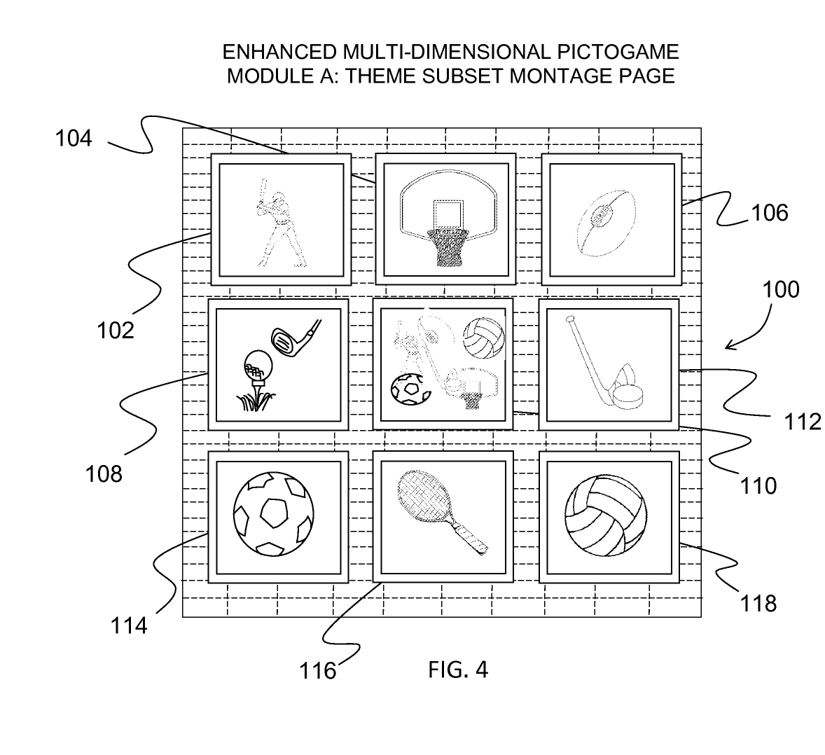

Using the PictoPuzzle as an example of a PictoGame 70, a second important feature of Module A is the constructions of the series of Montage Pages that include the Major Themes 74 and all of the Theme Subsets 76. In a first embodiment a Montage Page 100 is in a 3×3 format displaying nine pictorial elements. The Major Themes 74 are of a broader scope and encompass many topics, subjects and lessons that are broken out in the Theme Subsets 76. In a first embodiment, the Major Themes 74 are: 1. A General or Generic Theme that encompasses all other Major Themes; 2. Sports; 3. News and Facts; 4. Music; 5. Film and Television; 6. Hobbies; 7. Art; 8. Travel; 9. Food and Cooking. Selecting any Theme Subset displays a series of PictoPuzzles or other PictoGame 70 related to the Major Theme 74 and Theme Subset 76. As an example, a Theme Subset for Sports is shown in FIG. 4 and may as, an example, include A General or Generic Theme 110 that encompasses all Sports; Baseball 102, Basketball 104, Football 106, Golf 108, Hockey 112, Soccer 114, Tennis; 116, and Volleyball 118. By selecting the display for Baseball 102, a series of PictoPuzzles 270 are displayed which relate to many aspects of the game of baseball. The PictoPuzzles 270 may be team specific, may present great players with Challenges 57 on records and other statistics, or as an example the PictoPuzzle 270 may be related to the rules of baseball to dynamically educate and inform an End User.

### Details of Module A

### Structuring the Architectural Blueprint

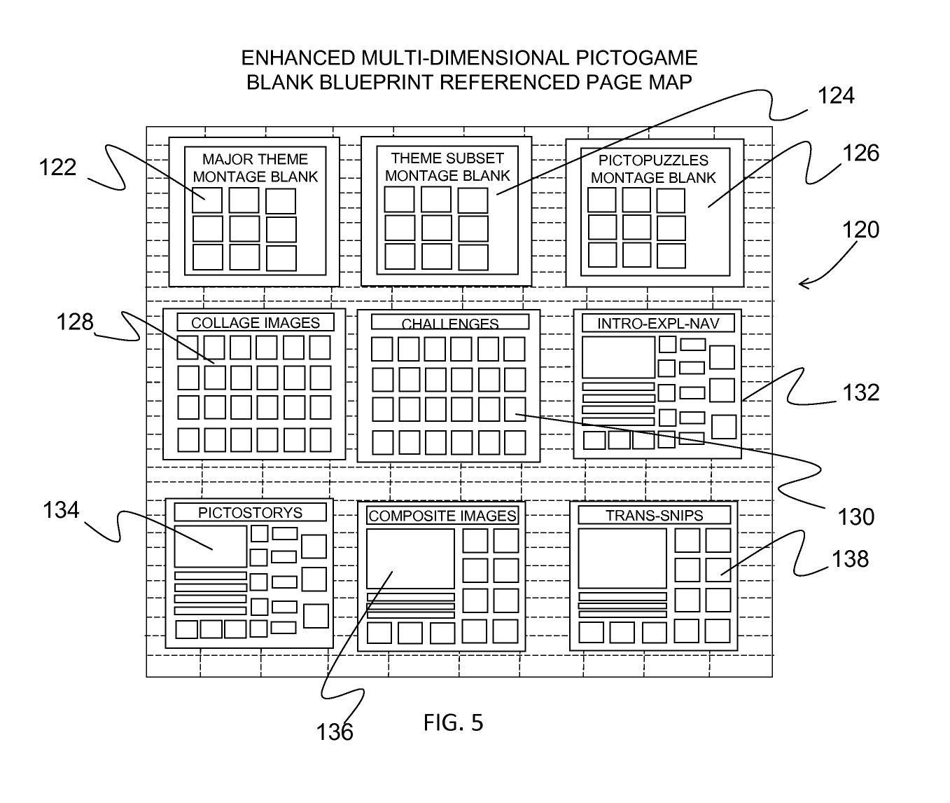

The series of PictoPuzzles are displayed in Montage Pages 100 and each are numbered and statistical information on success and scoring is maintained based on the number indicator. Using the Major Themes and Theme Subsets and Intro-Explain-Navigate Generator a Blank Architectural Blueprint is structured. The Blueprint Generator 60 also structures Multilevel Reference Coordinate System for the Blueprint and a Coordinate File Naming Structure for storage of PictoLayer and other Components in the Data Store Resource. The Blank Architectural Blueprint may structure locations for each of the PictoGame Component Pages as shown in FIG. 5. Each of the Component Pages is positioned with a coordinate reference location with the Referenced Page Map 120 of the Architectural Blueprint. By zooming in or out or selecting any of the Pages all of the Components of the PictoGame are accessible.

In a first embodiment using a PictoPuzzle PictoGame as an example placeholders and designated Coordinate Locations with the Coordinate File Naming structure are defined for the Montage Pages 100 for the Major Themes 122, Theme Subsets 124, and PictoPuzzles 126 as well as Coordinate Locations for the Collage Images 128, the Challenges 130, and the Introduction, Explanation and Navigations Presentations 132 are structured. Coordinate Locations and File Naming Structure are also formatted for the PictoLayers that form the Collage Images 128; the PictoStorys 134, the Composite Images 136 and the Trans-Snips 138. The Referenced Page Map 120 may be expanded to locate any number of Components and Sub-Components so that tens of thousands of PictoLayers may be located and used for a series of PictoPuzzles and the numerous levels of difficulty within each PictoGame.

### Details of Module B

### Formation of a Collage Image

A first feature in Module B is the Choice Generator 46 that transfers tens of thousands of files related to the Major Themes 73 and Theme Subsets 76 to be used in the formation of the Collage Images 42 used in one embodiment to play the PictoGame 70. The selected files are renamed using the encrypted Coordinate File Naming System based on the formatted Location Coordinate structure of the Architectural Blueprint and are stored in the Data Store Resource 48 in a Variable Output Folder for possible use in the PictoGame 70. The Coordinate File Naming Structure also provides an index so that files of similar Components and of similar subject matter are named similarly, such as with a code and coordinate position so that a group of related PictoLayers may be selected to create for example a Collage Image 42.

A Collage Image 42 as shown in a very basic diagrammatic representation in FIG. 5, are created from a series of transparent pictorial images or PictoLayers 44 that are aligned and layered on top of one another so that portions of images below show through the upper layers, forming a collage or decoupage pictorial image. By removing an upper layer more of the pictorial image of the lower layer is revealed. Using the E-Enhanced Multi-Dimensional PictoStory Application Software described in U.S. Provisional Application No. 61/705,686 the pictorial elements or PictoLayers 44 may be formed from Trans-Snips, Composite Images or PictoStorys which each displaying an increase in visual complexity as more pictorial elements are displayed.

### Details of Module B

### Formation of a Trans-Snip

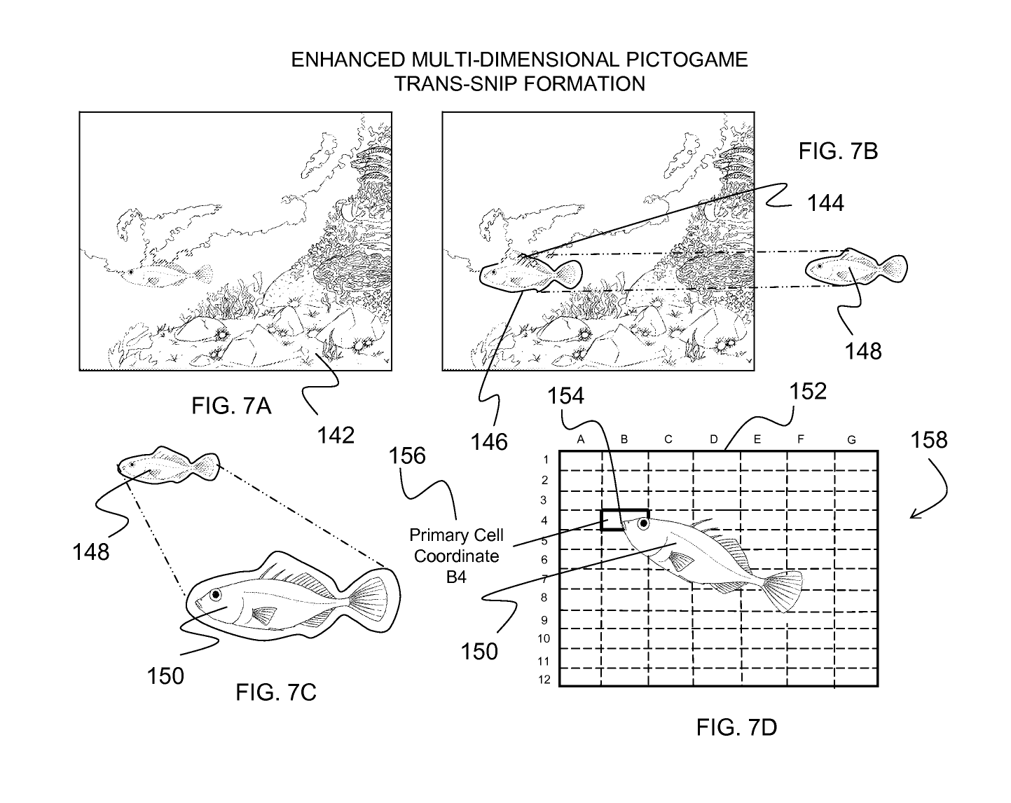

At the most visually basic level, as shown in FIGS. 7A-7D, a Raw Image 142 may be selected from the Variable Output File Folder of the Data Store Resource 48 using the PictoLayer Generator 32, and a portion of that image 142 that is related to the Major Theme or Theme Subset may be used. As shown in FIG. 7B, a cutting tool 144 allows for a portion of the image to be traced and cut out from a Raw Image 142. The Raw Image 142 may be shape cropped into multiple possible shapes including freehand, oval, rectangle, etc. In this example, a fish is outlined 146 and cut out in a fish shape 148 and dragged out of the image 142. The shape cropped image 148 is resized to any desired dimension within the horizontal and vertical limits of the parameters of the transparent blank resolution specifications. In this example, the fish cut out 148 is enlarged to form the Fish Pictorial Element 150. Software tools within the PictoLayer Generator 32 remove any white background that is created when using the cutting or snipping tool and the Fish Pictorial Element 150 is located on the Transparent Blank Referenced Resolution Cell Map 152. The Fish Pictorial Element 150 may further be rotated in any direction and then be given a cell reference location on the Transparent Blank 152 by aligning for example its furthest left highest point 154 to indicate in this example, the coordinate position of B4 indicated as 156 within the Resolution Cell Map 152. The resized, shaped cropped image with the white background removed and located at a reference coordinate on the Transparent Resolution Cell Map 152 forms a Trans-Snip 36.

The process and sub-components of a Trans-Snip 36 including the Raw Image 142 is displayed within the Populated Architectural or GameBoard Blueprint 120 as a Trans-Snip image 162, the cropping of the image 164, the sizing of the image 166, the removal of the white background 168, locating the image on the Resolution Cell Map 170, associating the image with one or more Enhancements 172, and forming the Trans-Snip layer 174. Using the Production Controls 27 of the Blueprint Generator 60, the Trans-Snip Page 160 further provides KeyConcepts Indicators 176 and a Navigation Toolbar 178 to select a process step image. Alternatives for each layer are also displayed with the Current PictoLayer 180, the Alternative PictoLayer 182, and the Raw Image of the Alternative PictoLayer 184.

### Details of Module B

### Formation of a Composite Image

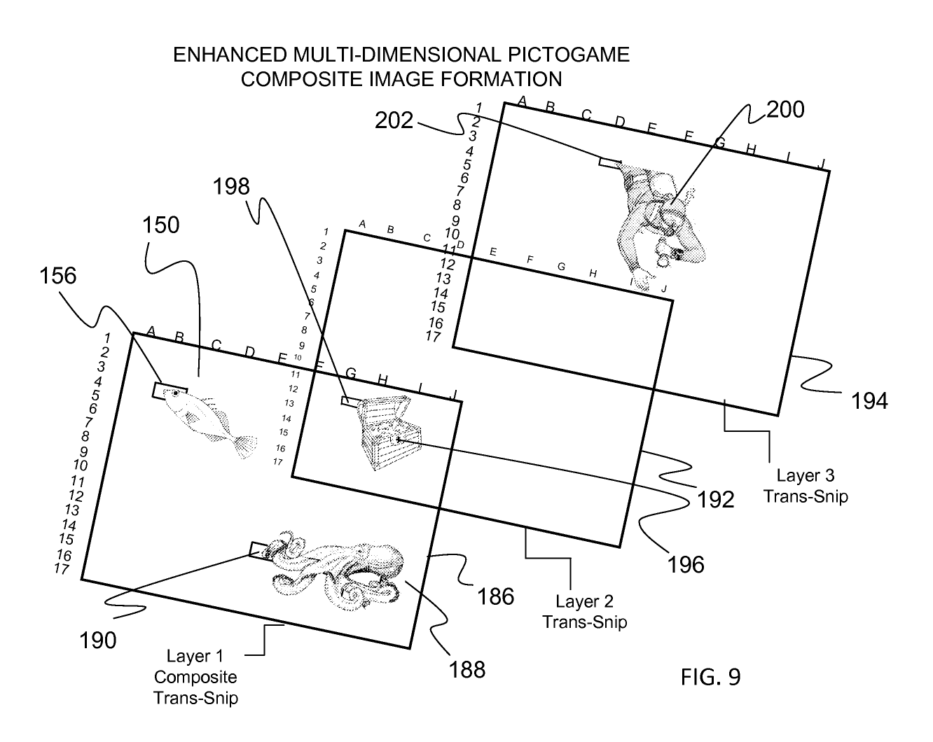

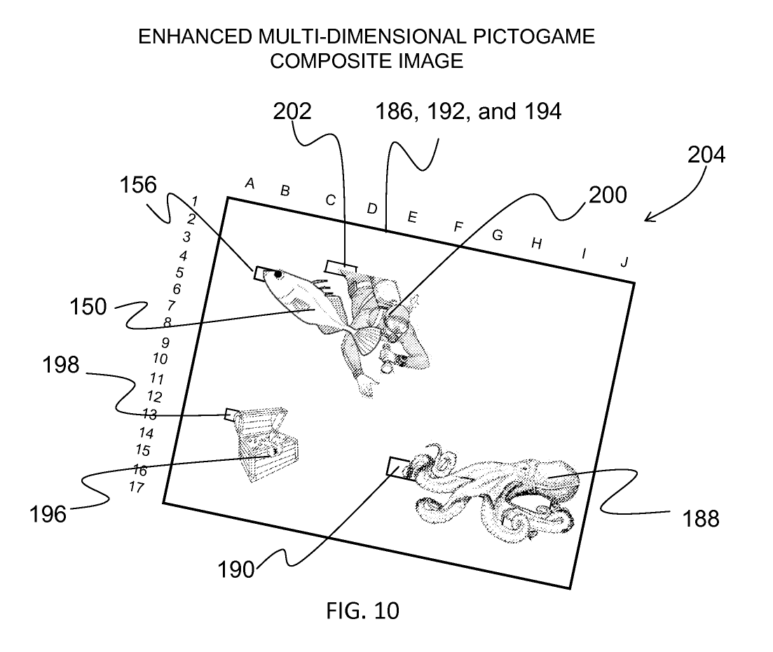

Using the PictoComposite Generator 34, a layered Composite Image 38 is formed from the layers of Trans-Snips 36. As shown in FIG. 9, a first Trans-Snip 186 may have any number of pictorial elements shown here with a first pictorial element of a fish 150 and an octopus 188 at location F13 indicated as 190. Any number of Trans-Snips 36 may be layered over or overlaid with other Trans-Snips 36 to create a Composite Image 38. In this example, additional Trans-Snips 192 and 194 include the pictorial elements of a treasure chest 196 located at F8 indicated as 198 and the Pictorial Element of a scuba diver 200 located at B7 and indicated as 202. FIG. 10 shows the aligned overlay of the three layers of Trans-Snips forming the Composite Image 204.

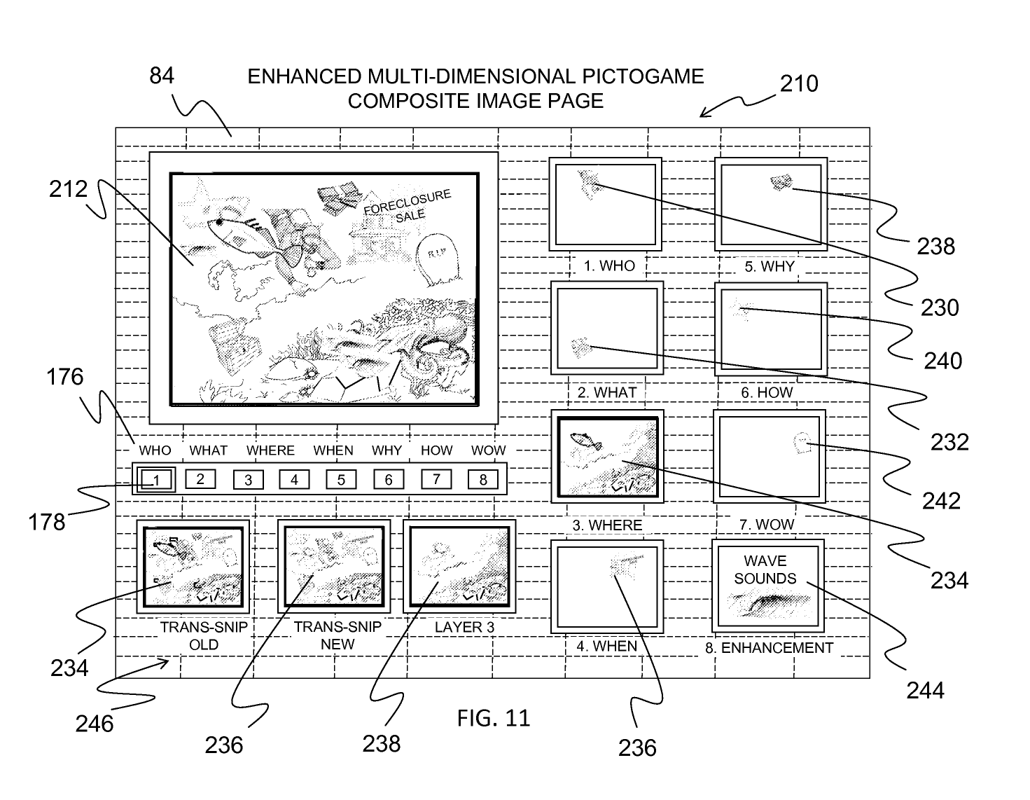

A Composite Image Page 210 is shown in FIG. 11 that includes the layered Composite Image 204 with additional Trans-Snip layers and each of the layered Trans-Snip Components and Sub-Components. In addition to the Resolution Cell Map 152, the Composite Image Page 210 provides the second coordinate system, the Referenced Cell Map 84 to navigate and modify the layered Trans-Snips 36 using the Production Tools 27 of the Blueprint Generator 60. Each of the Trans-Snip 36 are selected using the Choice Generator 46 so that they are related to the Major Themes and Theme Subsets to create a Composite Image 38. Using the PictoStory Application Software a Basic Idea is transformed through the application of a Key Concepts Query into an expanded Textual Outline 254 that provides answers to a series of questions which as displayed in this example are; a Who that is represented with a sea diver 230, a What that is a treasure chest 232, a Where that is underwater 234, a When that shows an event of a foreclosure on a home 236, a Why that shows a bundle of cash 238, a How that shows a great white shark 240, a What Happened that shows a gravestone 242 and an Enhancement 244 that has the sound of waves crashing on the beach dynamically and pictorially displaying a complex integrated Composite Image 212 formed from the layered Trans-Snips and Enhancements. Controls 246 to select Alternative Trans-Snips 248 with a display showing the Current Trans-Snip 234 and Alternative Trans-Snip 248 and the appropriate layer 252 are also available in the Composite Image Page 210.

### Details of Module B

### Formation of a PictoStory

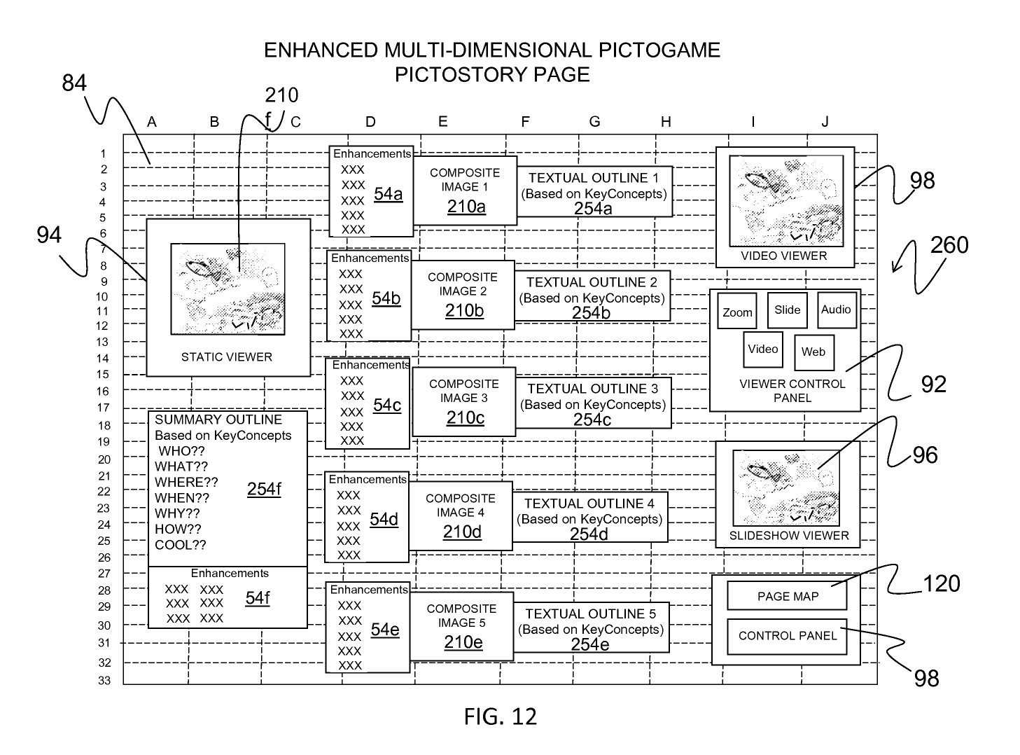

A PictoStory is formed from a series of Composite Images 38 and their Textual Outlines 254 that are located within an Architectural or PictoStory Blueprint 260. The Composite Images are then transformed using Enhancements 54 and are presented sequentially or in any desired order in a Multi-Dimensional Film-Like Presentation. Shown as an example in FIG. 12, the Composite Image 210f is a PictoStory Summary and is located on the Reference Page Cell Map 84 of the PictoStory Blueprint 260. The other Composite Images 210a-210e are also located in pre-formatted locations within the PictoStory Blueprint 260. The PictoStory Blueprint 260 also provides the three viewers to view the PictoStory, the Static Control Viewer 94, the Slide Show Viewer 96 and a Video Viewer 98. The layered Summary Composite Image Page 210f is shown statically and enlarged in the Control Viewer 94 for review and editing of its PictoLayers 44 and Components including Trans-Snip 158 and Enhancements 54 associated with the Composite Image 210f. The Outline Summary 254f is provided in this example below the Control Viewer 94 displaying the responses to the KeyConcepts Query. Access to the Enhancements 54f for the Summary Page 210f and Enhancements 54a-54e for the other Composite Images 210a-210e are accessible on PictoStory Blueprint 260 using their coordinate locations on the Referenced Page Map 120 that are represented as X's. As shown, any Trans-Snip 158 or layered Composite Image 210 may have multiple Enhancements 54 and access to the Enhancements 54 are designated within the Referenced Page Cell Map 84 as activation points, navigation buttons, hyperlinks or other markers that when selected run the Enhancement 54. The Viewer Control Panel 92 provides tools to render and activate all or a portion of the E-Enhanced Multi-Dimensional PictoStory Presentation. The rendering of the Presentation activates the associated Enhancements 54 to run any Subroutine, Software Application, URL, linkage, or other types of File Formats to dynamically present the PictoStory or any Challenges 57 associated with any of the PictoLayers 44 including the Collage Image 42, the PictoStorys 134, the Composite Image 38 or the Trans-Snips 36. Access is provided to the Reference Page Map 120 and Production Control Panel 98 within the PictoStory Blueprint 260.

### Module B

### Enhancements

Enhancements 54 provide the Challenges 57 as well as all of the audio and video effects for timing, sequencing and presentation. Associated at any of the Multi-Dimensional levels within any one or multiple PictoLayers and the Components and Sub-components one or a combination of cells, or any blank portion or populated portion of a PictoLayer may activate the Enhancement 54. Enhancements 68 by definition can be any further amplification, pictorial expansion or transition to a Sub-routine or indeed totally different URL or a fully interactive application that are activated and referenced by selecting a button, clicking a mouse, touching a screen or using any other operational control at the appropriate cell mapped reference points or the entire GameBoard Blueprint 30. The Enhancement 68 may be in numerous forms, including inter alia: Text, Narration, Music, Song, Slides, Animation, Count, etc. with interactive tools for navigation and data entry where required.

In a first embodiment, a series of PictoStorys 134 are constructed from Trans-Snips 36 and Composite Images 38 related to one of the Major Themes 74 or Theme Subsets 76. Using the Enhancement Generator 52, each PictoLayer 44 is associated with an Enhancement 54 that provides a Challenge 57 in the form of an answer, clue, story, character, joke or other important, fun, visually intriguing or other style of information. Enhancements may also add audio, video, sound and visual effects, movement, sequence and timing to the PictoLayers 44 with each layer upon layer is structurally ordered and enhanced creating in a first embodiment a Collage Image 42 that resembles a decoupage, or as referred to herein a PictoPuzzle 270. The PictoLayers 44 are associated through Hyperlinks, Sub-routines, Macros, Scripts and other software applications to one or more Enhancements 54. Enhancements 54 may be in any media format and may provide Animation, Text, Music, Narration Text, Audio, Audio Narration, Sound Effects, Video, Visual Effects and other any other format. Enhancements 54 are categorized and stored in the Data Store Resource 48.

An important feature of the invention is the use of Dynamic HTML with any PictoLayer, Page, Collage Image, PictoStory, Composite Image, Trans-Snip or any combination of each of these Components and Sub-Components. Using Dynamic HTML, a timing and sequence dimension may be added to the PictoLayers 44 to display each layer at different times, and in different orientations to create movement or provide a sequence to displayed events or Challenge requirements. Visual effects using D-HTML or other coded sub-routines may further be introduced to accentuate the visual image by zooming, panning, changing colors or focus or other features of the PictoLayer 44. Global visual effects may also link, order and sequence the PictoLayers with timing and structure to dynamically present each Challenge and PictoGame.

### Module B

### PictoGames First Embodiment PictoPuzzles and Challenges

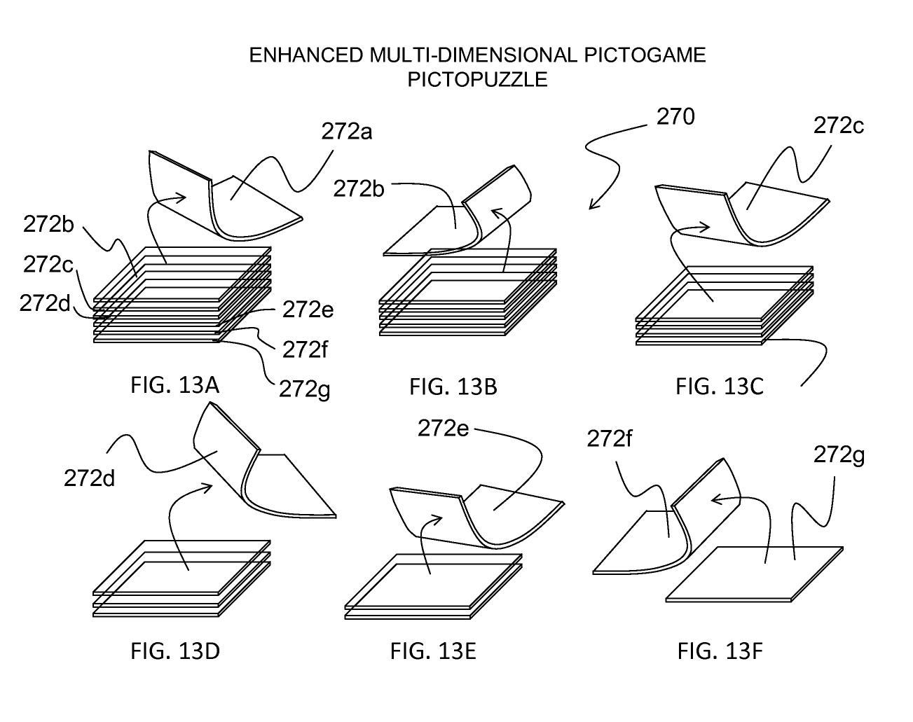

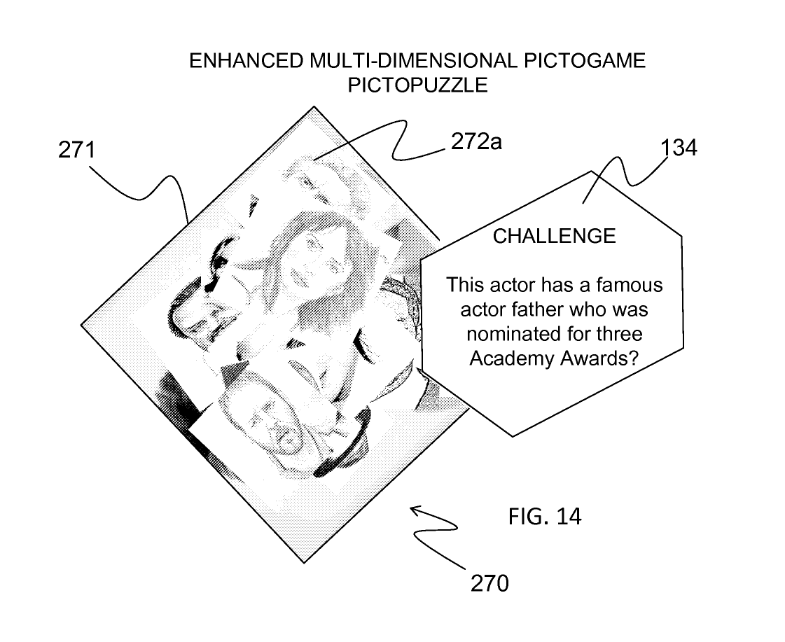

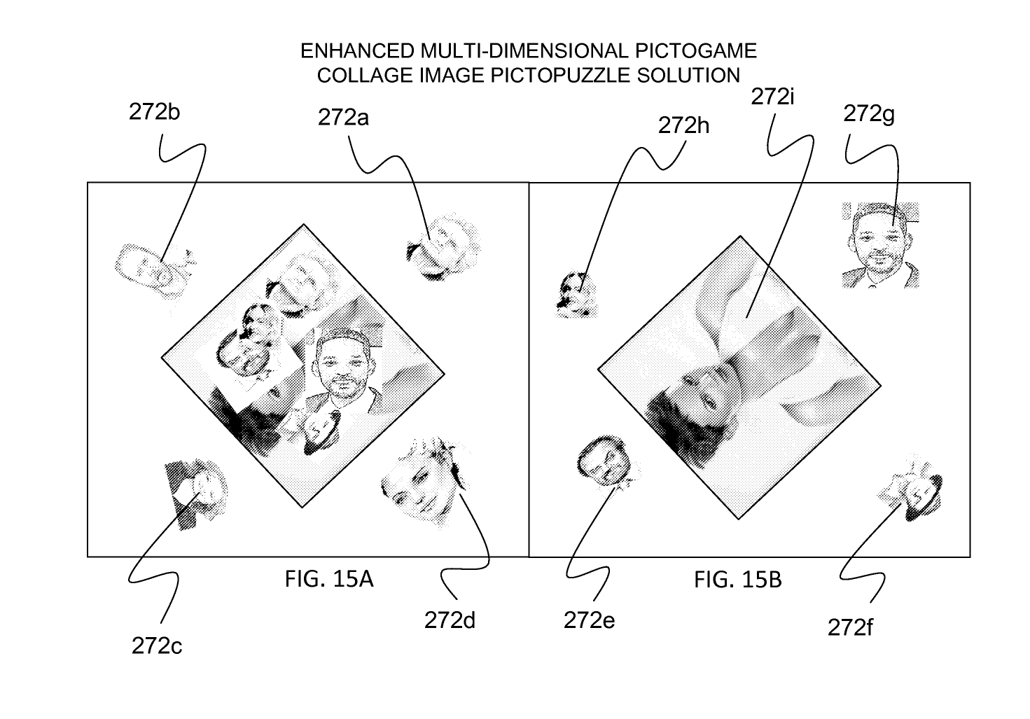

By structuring, enhancing and ordering each layer and associating Challenges 57 with the PictoLayers 44, the PictoPuzzle 270 as a first embodiment may be played by an End User by stripping out or peeling off each PictoLayer as shown in FIGS. 13A-13F. A Collage Image 42 is formed with a series of PictoLayers indicated as 272a-272g. In a first embodiment of the PictoPuzzle 270, a correctly answered Challenge removes PictoLayer 272a, a second correctly answered Challenge removes PictoLayer 272b and so on until a base PictoLayer 272g is revealed and the PictoPuzzle is completed. By means of elaborate and fun Challenges 57 that test skill, knowledge, imagination, musical ability, hand-eye coordination and intelligence the final base PictoLayer 272g may reveal a secret trophy or reward. As an example, shown in FIG. 14, the Collage Image 271 of the PictoPuzzle 270 may display pictures of well-known personalities and a selection must be made of the correct personality that performed in a specific movie, or who authored a specific book, or who landed on the moon, or any other variety of trivia questions that require the input of a correct answer by selecting the correct character to remove the PictoLayer. A correct answer and the next Challenge 57 related to the PictoPuzzle images may be presented. In this example, the Challenge 57 is in the form of a trivia question; “This actor has a famous actor father who was nominated for three Academy Awards?” By removing the PictoLayer 272a with the image of Michael Douglas the next Challenge will be presented. As shown in FIGS. 15A and 15B each correctly answered Challenge 57 reveals more of the PictoLayers 272a-272h underneath until the base PictoLayer 272i is reached revealing in this example a picture of Halle Barry.

The PictoPuzzle and PictoGame Presentations have been developed from PictoStorys that are associated with a Major Theme and Theme Subset topic, subject or lesson, so each may communicate information within and about that Theme. These PictoStorys within the PictoPuzzle Presentations are not in any way simply a set of static images overlaid on top of one another. By using Enhancements, the PictoPuzzle images are dynamically transformed creating for example a first, second or third event within a timed sequence, or zooming in or out of the PictoLayer 272 to display a correct selection or provide a hint or other information, or that narrate and explain the pictorial images, or that provide background music, or that use spoken words to request or provide information, or that applaud and congratulate a correct answer thereby providing an infinite possibility of Challenges 57 and entertainment.

By presenting the PictoPuzzle visually, the series of images may inform and educate and then require input from the user to select or describe the information and in this way prove understanding of the information. An answer that requires a question may be presented in a jeopardy type format with a pictorial representation of the person of interest; “He was the first man to fly solo around the world.” A vintage airplane may swoop across the screen with a map of the world and a picture of the aviator so that the correct answer must be selected from a multiple choice dialog box or must be entered to correctly answer, Wiley Post, to move to the next PictoLayer 272. Other Challenges 57 could be in the form of mathematical problems, Sudoku, or a wheel of fortune type game where a word or phrase is completed by showing more of a pictorial image as each correct letter is entered until each layer is pulled off revealing the correct word or phrase.

Importantly, the PictoPuzzle 270 displays a series of images without any background and therefore one image blends into a lower image and therefore to truly see the image below, the upper images must be removed in a layer by layer fashion through the series of Challenges 57, similar to ‘peeling an onion’ layer by layer in an interactive and entertaining way that may be timed, point scored, assisted by helpers, contest driven, available to teams and/or competitively played against one or more opponents. After fully peeling the PictoPuzzle onion, a trophy, reward, high score or other item is revealed in a truly fun, comical, musical, rewarding, informative way. The final reward may be an Enhanced Multi-Dimensional Presentation that presents in an audio/visual film-like manner a summary of the Theme Subset 76 or biographical story about the revealed character.

### Module B

### PictoPuzzles and PictoGames Further Embodiments

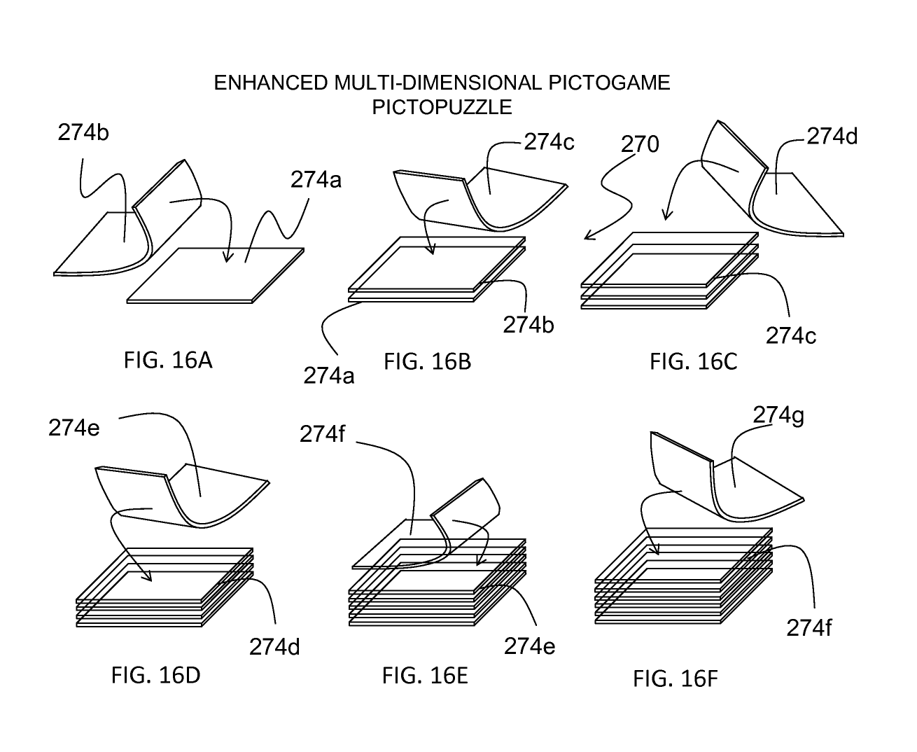

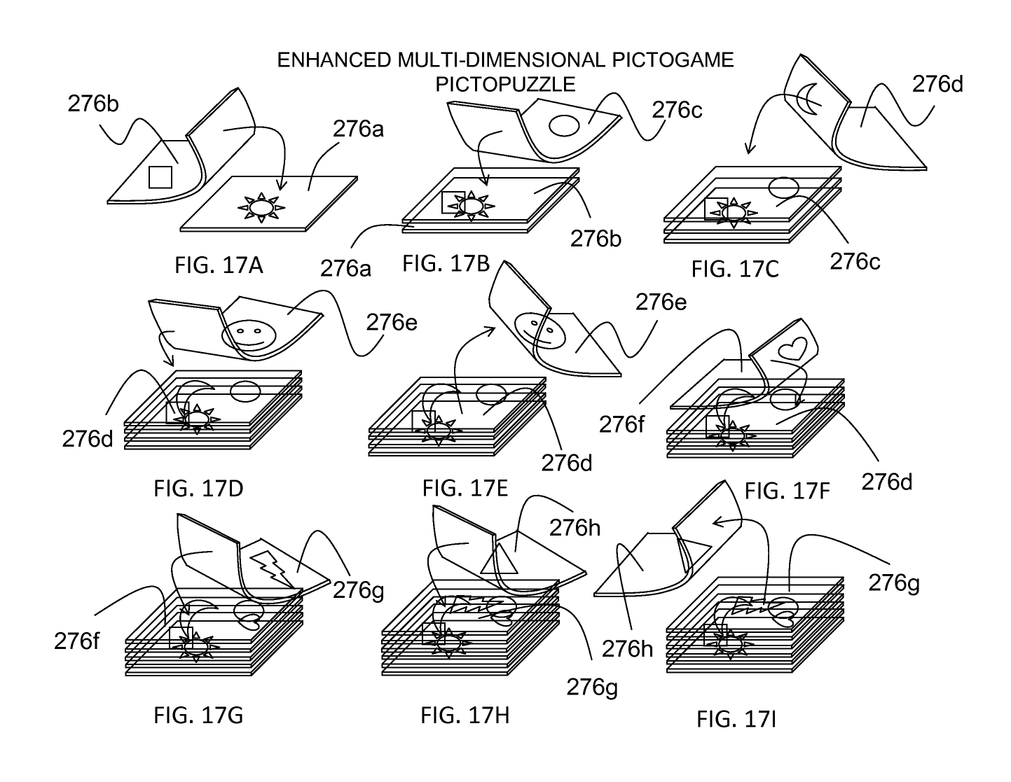

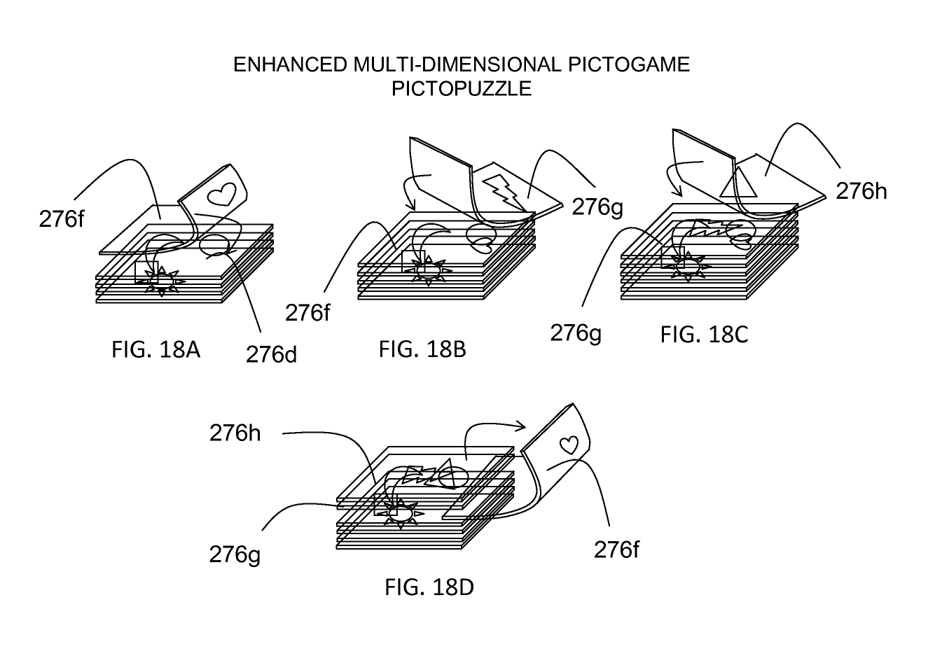

In further embodiments, the PictoPuzzles 270 and other PictoGames 70 may instead add PictoLayers 274 or both add remove PictoLayers 276 as Challenges 57 are correctly completed, or incorrectly completed. For an incorrect answer a PictoLayer may instead be added not taken away. As shown diagrammatically in FIGS. 16A-16F, the PictoPuzzle begins with a first PictoLayer 274a that may have a partial image. A second PictoLayer 274b also with a partial image is overlaid on top of PictoLayer 274a. Similar to a jigsaw puzzle, for each correctly answered Challenge 57, PictoLayer 274c through 274f are added until a final Challenge 57 adds the final PictoLayer 274g completing and revealing the “secret” image. In a further embodiment, shown in FIGS. 17A-17I, both adding and removing of PictoLayers are performed as Challenges 57 are completed. FIGS. 17A-17D show the addition of PictoLayers 276A-276E as Challenges are presented and completed. FIG. 17E shows the removal of PictoLayer 276E which may be because a Challenge 57 was incorrectly completed or an opponent targeted and annihilated the layer, or for other consequences with respect to the Challenge 57. FIGS. 17F-17H show the addition of a subsequent PictoLayers 276f, 276g and 276h and then the removal of 276h demonstrating that as a PictoGame progresses a varied presentation of PictoLayers may be shown to continually visually change the Collage Image 42 creating interesting and engaging Multi-Dimensional PictoGame Presentations. In further embodiments, PictoLayers 276f-276h are initially added as shown in FIG. 18A-18C, and then a lower PictoLayer 276f is removed from the PictoPuzzle 270 as a result of the completion of the Challenge 57.

### Module B

### Alternative PictoLayers using the Random Generator

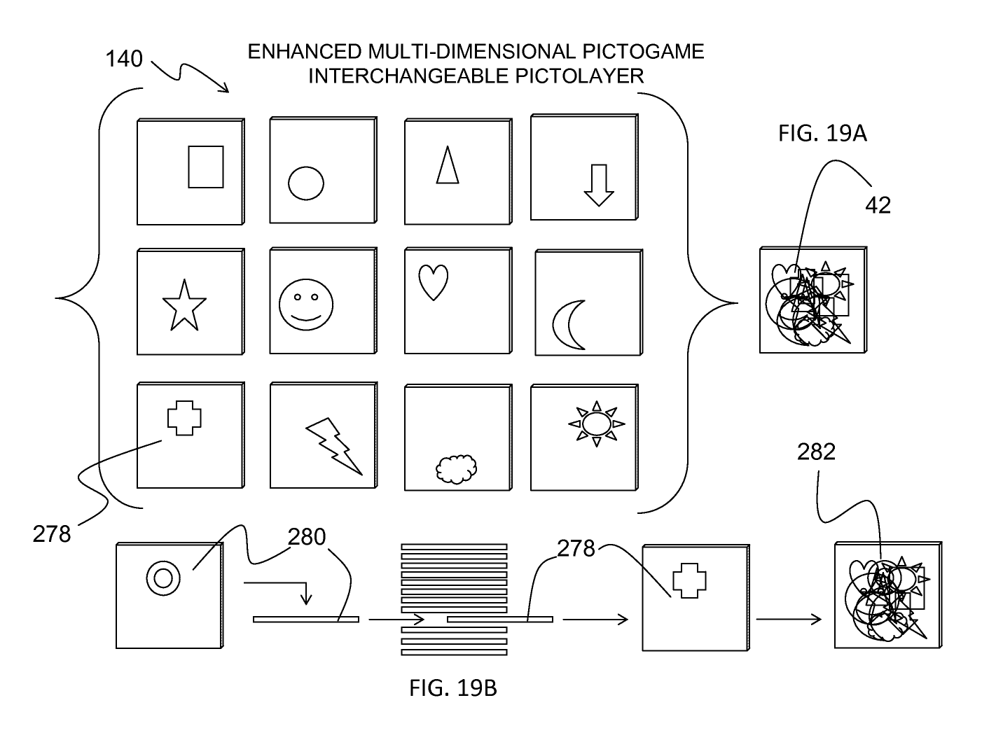

Using the Random Generator within the PictoGame Production Control Tools of Module B any PictoLayer 44 within a PictoPuzzle 270 may be seamlessly replaced with an Alternative PictoLayer 58. As shown diagrammatically in FIG. 19 the Collage Image 42, is made up of a series PictoLayers 140 that include PictoStorys 40, Composite Images 38, Trans-Snips 36, and Enhancements 54 that form the PictoPuzzle 270 or other PictoGame and series of Challenges 57. While any PictoLayer is replaceable, the selected PictoLayer 44 may be referred to herein as the Interchangeable PictoLayer 278 and may be automatically replaced with the Alternative PictoLayer 280 by randomly selecting from the Alternative PictoLayers 58 that have been categorized and Indexed within the Variable Output Folder by the Choice Generator 46 based on the Major Themes 74 and Theme Subsets 76. A correct response or incorrect response to a Challenge 57 may cause the random selection of the Alternative PictoLayer 280 or a transition to a new Enhancement 54 that presents a new Challenge 57 and changes the Collage Image 42 to a new Collage Image 282 as shown.

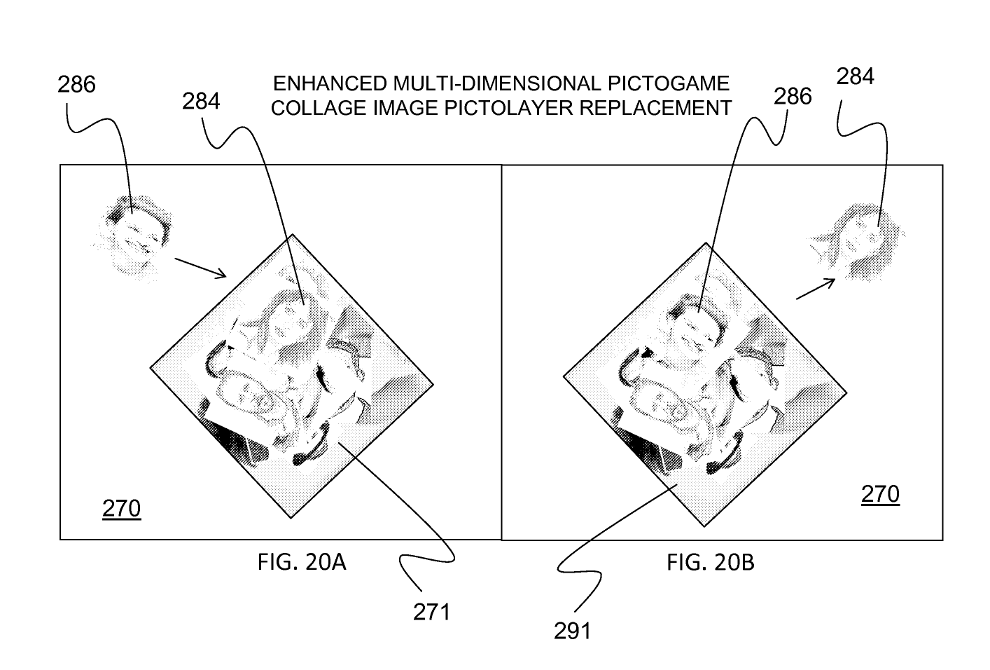

As an example, shown in FIGS. 20A and 20B, the Interchangeable PictoLayer 284 that represents an image of Penelope Cruz may be replaced with the Alternative PictoLayer 286 representing an image of Julia Roberts and changing the Collage Image 271 to a new Collage Image 291 within the PictoPuzzle 270. The replacement is seamless where the Interchangeable PictoLayer 284 is immediately replaced by accessing and re-naming the Alternative PictoLayer 286 with the Coordinate File Name matching the grid position of the Interchangeable PictoLayer 284 within the GameBoard Blueprint 30 and moving the Alternative PictoLayer 286 into the Output File Folder. The Collage Image 271 is immediately changed to Collage Image 291 and Enhancements associated with the Alternative PictoLayer 286 are immediately activated and accessible to the End User. The complete operation may occur while the PictoPuzzle 270 is being played, in this way creating an infinitely variable visual displays and Challenges 57 within the PictoGame 70.

### Module C

### Features of the Production Presenter

The PictoPuzzle 270 or PictoGame 70 may be on any subject or combination of subjects and may be presented on a mobile device for diversion and entertainment or be expanded to a three-dimensionally active device where speed and skill are used to rapidly complete each Challenge 57 to beat an opponent or quickly reach the prize. The PictoPuzzle 270 may further be an interactive trivia game where multiple players interact and discuss each decoupage of images to determine a best solution or approach for advancement. The thematic representation of the PictoPuzzle 270 also provides for theme specific Challenges 57 to represent a holiday or event or to educate a user on a specific hobby, topic, subject or skill.

A general division of formats are referred to herein as PictoPuzzle Games, PictoParlor Games and PictoVideo Station Games all that may be run on different media platforms, however for example the PictoPuzzle Game may be formatted particularly for a mobile device format, PictoParlor Games may be in a group based family fun format on a tablet computer, personal computer or other electronic communication device, and PictoVideo Station Games may be formatted for a physically interactive format such as on a WII, XBox, or Play Station. In any format the PictoGames present challenging competitive games that allow an End User to test their cognitive and hand eye coordination skills in order to score points, beat a time score or outdo one or more opponents.

The Production Presenter 300 of Module C properly formats the PictoGame for the selected media format and provides access to the PictoGame 70 that in a first embodiment may be a series of PictoPuzzles 270. The Production Presenter 300 provides an initial login screen 302 with a User Name and Password Dialog Box 304, access to download one or more PictoGames 306 and an optional link to Connect to Opponents 308. The Video Presentation Screen 310 provides access to view the Introduction Presentation 312, the Explanation Presentation 314 and the Navigational Presentation 316. An active display of the Major Themes 318 and Theme Subsets 319 may be provided to dynamically flip through and present options for the subject matter of the PictoPuzzle 270 or other PictoGame 70. The End User may view the Presentations and select from the Major Theme Display 318 and Theme Subset Display 319 to begin the PictoGame 70.

Importantly, the Major Themes 74 and Theme Subsets 76 have driven the development of the PictoPuzzle 270 and each successive PictoLayer 44. The derivation of suitable images to create the PictoLayers 44 is automated using the Choice Generator 46 and the Variable Output Folder and Coordinate File Naming structure of the Data Store Resource 48. The Major Themes 74 and Theme Subsets 76 provide a wide range of subject matter for the thematic representation that is then used to format the Data Store Resource 48 with tens of thousands of related images. As an example, a Major Theme 74 may be car racing, with a Theme Subset 76 of Formula 1 Racing. The PictoPuzzle may include; a specific Formula 1 race car winning a specific Formula 1 race with a specific Formula 1 race car driver and a specific manufacturer of the Formula 1 race car. Each PictoLayer 44 may provide Challenges 57 related to any of these topics, what kind of car, who is the race car driver, wow what happened at the race? The user is not simply told this Formula 1 race car driver won this Formula 1 race on this day in this Formula 1 race car, but instead through the dynamic Multi-Dimensional Presentation of the PictoPuzzle or in other PictoGames, the user is fully engaged and informed of many aspects of Formula 1 Racing, the manufacturers of Formula 1 race cars, the requirements and challenges facing a Formula 1 driver as drive at speeds over 200 miles per hour and the special event of one particular race where a certain Formula 1 driver won. The Multi-Dimensional PictoLayers and vivid Pictorial Representations and Challenges create a deep interaction of the End User with the subject matter of the PictoGame and thereby assisting in having the End User more easily retain the information presented than would normally be retained.

### Module C

### Playing the PictoGame Using the End User Software Application

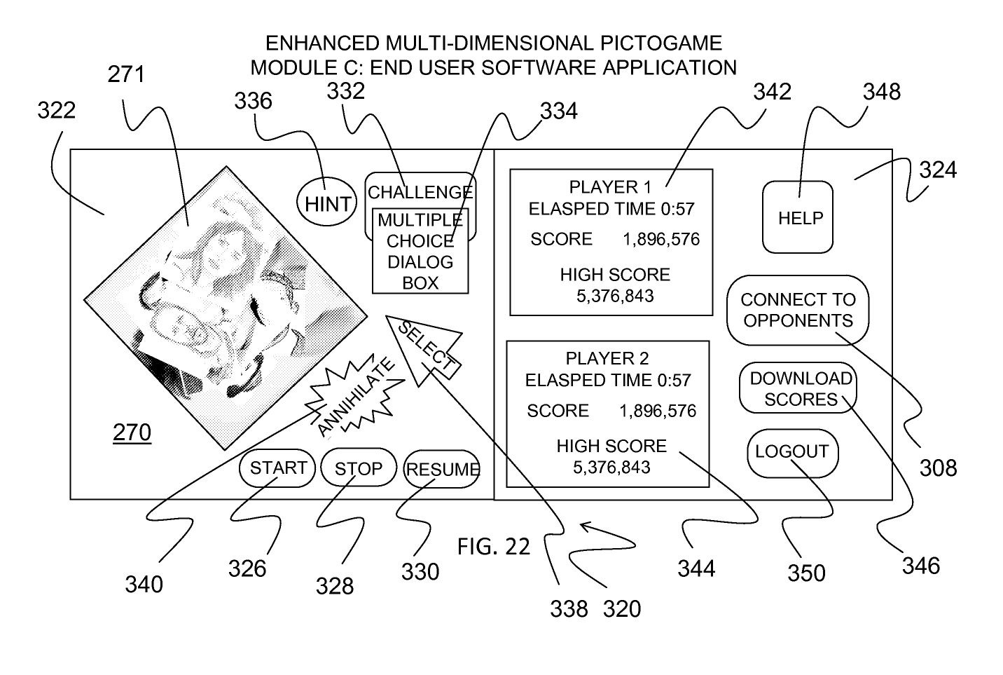

Selecting from the Theme Subset Display 319, a series of PictoPuzzles 270 or other PictoGames 70 are displayed and with a selection the End User Software Application presents the PictoGame Display Screen 320. In a first embodiment shown in FIG. 22, the PictoGame 70 is the PictoPuzzle 270. The PictoGame Display Screen 320 may be divided between a GameBoard Screen 322 that includes the PictoPuzzle 270 and a Control Panel 324. The GameBoard Screen 322 includes all of the controls to play and interact with the PictoPuzzle 270. For example, a series of control buttons may Start 326, Stop or Resume 328 the PictoGame 70. A Challenge Button 332 may provide access to display Challenges 57 and one or more Dialog Boxes 334 may display for data entry to respond to one or more Challenges 332. A Hint Button 336 may be selected by End User to be given a clue or additional help to complete the Challenge 57. A Select Button 338 may provide for selection within the PictoPuzzle 270 to add or remove a PictoLayer 44 from the PictoPuzzle 270.

An important feature available within the PictoGame Display 320 is the “Annihilate” or “Kill Button” 340 that presents a high risk increased rewards Challenge 57 that if correctly completed provides the End User with a greatly increased scores, or subtracts a significant score from an opponent. A failure in completing the Challenge 57 will result in a significant loss of points to the End User or a substantial increase in points for the Opponent. Alternatively, instead of an increase in points a significant reduction or increase in Elapsed Time may be the reward or detriment. As shown in the Control Panel 324, one or more player's scores may be presented. In this example, the Player 1 Score Box 342 and Player 2 Score Box 344 include scoring for Elapsed Time, Point Score, and Highest Point Score. Other parameters to track and access skill and improvement may further be within the scope of the present invention, with all scores for every player, team, opponent or opponent teams recorded and saved by selecting the Download Scores Button 346 or ending the PictoGame 70. Other features include a Help Button 348 to provide further information and the Connect to Opponents to competitively engage others through a wireless or internet connection. The Logout Button 350 exits the End User from the PictoGame 70.

Using expressive pictorial images and elaborate and fun enhancements, PictoGames 70 test skills, knowledge, imagination, musical ability, hand-eye coordination and other cognitive proficiencies. The PictoGames may be played in a variety of formats including mobile device, tablet computers, video gaming stations or large scale video gaming tournament displays where teams of users compete to answer each Challenge to complete the PictoGame. Every variety of presentation and display for the PictoGames are contemplated within the scope of this invention.

The invention has been described in detail with particular reference to certain preferred embodiments thereof, but it will be understood that variations and modifications can be effected within the spirit and scope of the invention. The claims should not be read as limited to the described order or elements unless stated to that effect. Therefore, all embodiments that come within the scope and spirit of the following claims and equivalents thereto are claimed as the invention.

What is claimed is:

1. A software system for the creation of an enhanced multi-dimensional pictogame, comprising:
application software installed on a computer system;
the application software further comprising;
a choice generator;
a pictolayer generator;
a pictocomposite generator;
an enhancements generator; and
a game board blueprint; and
wherein a plurality of pictolayers are formed from at least one raw image using the pictolayer generator;
the plurality of pictolayers are layered using the pictocomposite generator to form a pictopuzzle;
the pictopuzzle is located within the game board blueprint and enhanced using the enhancements generator;
a plurality of challenges are associated with the pictopuzzle; and
the completion of at least one of the plurality of challenges results in a modification to the pictopuzzle and a score in an enhanced multi-dimensional pictogame.

2. The software system for the creation of an enhanced multi-dimensional pictogame of claim 1, wherein the plurality of pictolayers are one of at least a trans-snip, a composite image and a pictostory.

3. The software system for the creation of an enhanced multi-dimensional pictogame of claim 1 wherein the completion of a challenge results in the adding of a pictolayer to the pictopuzzle.

4. The software system for the creation of an enhanced multi-dimensional pictogame of claim 1 wherein the completion of a challenge results in the removal of a pictolayer from the pictopuzzle.

5. The software system for the creation of an enhanced multi-dimensional pictogame of claim 1 wherein the completion of a challenge results in the addition and removal of at least one pictolayer.

6. The software system for the creation of an enhanced multi-dimensional pictogame of claim 1 wherein at least one challenge from the plurality of challenges presents at least one dialog box for data entry.

7. The software system for the creation of an enhanced multi-dimensional pictogame of claim 1 further comprising a random generator for the replacement of a pictolayer with an alternative pictolayer.

8. The software system for the creation of an enhanced multi-dimensional pictogame of claim 1 further comprising the presentation of one of at least an introduction presentation, an explanation presentation and a navigation presentation.

9. The software system for the creation of an enhanced multi-dimensional pictogame of claim 1 wherein the choice generator selects from a plurality of pictolayers related to a theme and renames one of the plurality of pictolayers with a coordinate file name matching a coordinate of the game board blueprint coordinate system to include in the pictopuzzle.

10. The software system for the creation of an enhanced multi-dimensional pictogame of claim 9 wherein the coordinate file name is encrypted.

11. The software system for the creation of an enhanced multi-dimensional pictogame of claim 1 further comprising a production presenter for the presentation of the pictopuzzle and the enhanced multi-dimensional pictogame in a media format for display on one of at least a cellular phone, a smartphone, a tablet computer, and a computer monitor.

12. A method of creating a pictorial game, comprising the steps of:
accessing application software installed on a computer system;
selecting a series of themes and theme subsets;
forming at least one pictolayer related to one of the themes and theme subsets;
selecting a plurality of pictolayers related to one of the themes and theme subsets;
creating at least one pictopuzzle from the plurality of pictolayers related to at least one of the series of themes and theme subsets;
associating at least one enhancement with one of at least the plurality of pictolayers and at least one pictopuzzle;
developing a plurality of challenges related to the series of themes and theme subsets;
completing at least one challenge from the plurality of challenges;
recording a score for the completion of at least one challenge from the plurality of challenges; and
modifying at least one pictopuzzle.

13. The method of creating a pictorial game of claim 12, further comprising the steps of modifying at least one pictopuzzle by adding at least one pictolayer to at least one pictopuzzle.

14. The method of creating a pictorial game of claim 12, further comprising the steps of modifying at least one pictopuzzle by removing at least one pictolayer from at least one pictopuzzle.

15. The method of creating a pictorial game of claim 12, further comprising the steps of modifying at least one pictopuzzle by adding at least one pictolayer and removing at least one pictolayer from at least one pictopuzzle.

16. The method of creating a pictorial game of claim 12, further comprising the steps of creating a dialog box for the entry of data to complete at least one challenge from the plurality of challenges while playing the pictorial game.

17. The method of creating a pictorial game of claim 12, further comprising the steps of replacing at least one pictolayer from the plurality of pictolayers with an alternative pictolayer within at least one pictopuzzle while playing the pictorial game.

18. The method of creating a pictorial game of claim 12, further comprising the steps of presenting one of at least a comprehensive introduction presentation, explanation presentation and navigation presentation about the pictorial game.

19. The method of creating a pictorial game of claim 12, further comprising the steps of formatting the pictorial game to be presented for display on one of at least a cellular phone, a smartphone, a tablet computer, and a computer monitor.
